(19) United States
(12) Patent Application Publication
(10) Pub. No.: US 2025/0385618 A1
(43) Pub. Date: Dec. 18, 2025

(54) Systems and Methods for a Three-Phase Partial Power Processing Inverter

(71) Applicant: The Trustees of Columbia University in the City of New York, New York, NY (US)

(72) Inventors: Matthew Jahnes, New York, NY (US); Matthias Preindl, New York, NY (US)

(73) Assignee: The Trustees of Columbia University in the City of New York, New York, NY (US)

(21) Appl. No.: 19/239,530

(22) Filed: Jun. 16, 2025

Related U.S. Application Data
(60) Provisional application No. 63/660,180, filed on Jun. 14, 2024.

(51) Int. Cl. H02M 7/5387; H02M 1/00

(52) U.S. Cl. CPC H02M 7/53871; H02M 1/0058

(57) ABSTRACT

Disclosed are systems, method, devices, and other implementations, including a voltage inverter system that includes multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side, and one or more controllers to control electrical operation of the multiple modular phase circuits. In some embodiments, the reconfigured stacked DAHB circuits of the multiple modular phase circuits may be configured to perform partial power processing. In some examples, the controllers can be configured to maintain soft-switching operations for switching devices coupled to capacitors of the stacked DAHB circuits, or maintain substantially constant switching frequencies for the stacked DAHB circuits.

### CROSS-REFERENCE TO RELATED APPLICATIONS

This application claims priority to, and the benefit of, U.S. Provisional Application No. 63/660,180, entitled “SYSTEMS AND METHODS FOR THREE-PHASE PARTIAL POWER PROCESSING SOFT-SWITCHED INVERTER” and filed Jun. 14, 2024, the content of which is incorporated herein by reference in its entirety.

### STATEMENT REGARDING FEDERALLY SPONSORED RESEARCH

This invention was made with government support under grant No. 1653574 awarded by the National Science Foundation (NSF). The government has certain rights in the invention.

### BACKGROUND

Partial Power Processing (PPP) converters are a unique category of power converters, where the power processed internally by the converter is less than the output power of the converter. This is enabled by allowing a portion of the output power to flow through the converter unprocessed. The amount of power that ultimately has to be processed by the converter is dependent on its voltage conversion ratio, which is a feature that can be leveraged in the design process.

PPP converters have proven applications in the areas of photovoltaic integration, battery charging, and LED driving. These are all DC-DC applications where the PPP converter operates within a relatively limited range of voltage conversion ratio. This allows for the design to be optimized for operation within this range. Applications of PPP converters to AC systems are limited. They are largely based around two-stage inverters where the PPP converter is used as a DC/DC stage and the AC interface is any variant of a full power processing (FPP) converter.

### SUMMARY

The proposed implementation are based on a three-phase PPP inverter framework where each phase of the AC grid is serviced by a stacked DAHB (dual-active-half-bridge). Analysis of the stacked DAHB in the context of the Manhattan Topology, as well as the influence of the dynamic operating points, over a cycle of the grid shows that the PPP configuration of the stacked DAHB improves the overall efficiency, even as an AC interface, when compared with the efficiency of just the DAHB over these same operating points. Under the proposed PPP approach soft-switching of the DAHB over the cycle of the grid can be maintained.

In various implementations, the proposed three-phase PPP AC inverter is constructed from three phase-modular stacked DAHBs, with each DAHB being a power processing unit. It is shown through both experimental results and theoretical computations that the application of PPP converters to AC systems can be used to improve overall efficiency. As will be discussed in greater detail below, the phase-modular stacked DAHB can be analyzed within the framework of the Manhattan Topology (a multilevel converter topological family defined by a set of series stacked capacitors in which power can controllably be transferred between capacitors). Analysis of the inverter follows the change in operating points over one cycle of the grid, most notably the dynamic voltage conversion ratio of the DAHB and the performance characteristics that are defined by it. Two control schemes are provided and discussed, one with a constant switching frequency for hard-switched DAHB applications and another with a variable switching frequency. The variable switching frequency is used to keep the stacked DAHB within its soft-switching region over the cycle of the grid and its associated large range of voltage conversion ratios. Lastly, a 3 kW experimental prototype is constructed using GaN FET devices, using a switching frequency of up to 1 MHz. Experimental efficiency, current quality, transient, and power step results are provided for the two different control schemes. As described below, experiments to test and evaluate the proposed framework show that the PPP configuration offers a >9% efficiency improvement over the efficiency of the processed power, and the soft-switching scheme offers a 2-4% efficiency improvement over the hard-switched scheme.

Thus, in some variations, a voltage inverter system is provided that includes multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side, and one or more controllers to control electrical operation of the multiple modular phase circuits.

Embodiments of the voltage inverter system may include at least some of the features described in the present disclosure, including one or more of the following features.

The reconfigured stacked DAHB circuits of the multiple modular phase circuits may be configured to perform partial power processing.

The reconfigured stacked DAHB circuits configured to perform partial power processing can be configured to have at least part of input power to the respective reconfigured stacked DAHB circuits bypass the galvanic isolations between the primary side and the secondary side of the respective reconfigured stacked DAHB circuits.

The one or more controllers configured to control electrical operation of the multiple modular phase circuits can be configured to perform one of, for example, maintain soft-switching operations for switching devices coupled to capacitors of the respective reconfigured stacked DAHB circuits, or maintain substantially constant switching frequencies for the respective reconfigured stacked DAHB circuits.

The multiple modular phase circuits may include three modular phase circuits.

Each reconfigured stacked DAHB circuit may include a primary section including two primary capacitors arranged in series, two switching devices arranged in series, with the series arrangement of the two primary capacitors placed in parallel to the series arrangement of the two primary switching devices, and a primary inductive element connecting a common terminal of the two primary capacitors and a common terminal of the two primary switching devices. The each reconfigured stacked DAHB circuit may also include a secondary section including two secondary capacitors arranged in series, two secondary switching devices arranged in series, with the series arrangement of the two secondary capacitors placed in parallel to the series arrangement of the two secondary switching devices, and a secondary inductive element connecting a common terminal of the two secondary capacitors to a common terminal of the two secondary switching devices, with a terminal of one of the two primary capacitors being electrically coupled to a terminal of one of two secondary capacitors, and with the primary inductive element being inductively coupled to the secondary inductive element.

The primary and secondary inductive elements may correspond to a primary winding and a secondary winding of a transformer corresponding to the galvanic isolation.

Each of the reconfigured stacked DAHB circuits can include one or more controllable switching devices, and the one or more controllers can include sensor devices, connected to the output of the voltage inverter system, to measure grid currents and output voltages produced by the multiple modular phase circuits, a phase-locked-loop (PLL) device to determine the instantaneous phase, θ, of the electrical grid, and one or more processor-based devices. The one or more processor-based devices can be configured to transform, based at least on the determined instantaneous phase θ, the measured grid currents and output voltages into transformed grid current and output voltages in a dq0 space, and derive based on the dq0 transformed grid currents and output voltages switch actuation signals to actuate the one or more controllable switching devices of the each reconfigured stacked DAHB circuit.

The one or more processor-based devices configured to derive switch actuation signals may be configured to derive for each of the stacked DAHB circuits, from the respective multiple modular phase circuits, based on the dq0 transformed grid currents and output voltages, control values for control variable, ζᵢ, with i identifying the multiple modular phase circuits, to control electrical behavior of the respective stacked DAHB circuits, and determine, based on the control values for ζᵢ, switch frequencies, f_{sw,i}, of control signals applied to respective switching devices of the each of the stacked DAHB circuits, and phase differences, ϕᵢ, between the control signals for each of the stacked DAHB circuits.

The control values ζᵢ may each be related to the power transferred across respective inductive couplings of the stacked DAHB circuits according to P_{ϕ,i}=KᵢV_{C,u,i}V_{C,l,i}ζᵢ, with

$${K}_{i} = \frac{{N}_{p , i}}{{N}_{s , i} 8 {f}_{sw , i} {L}_{Lk , i}} ,$$

with ζ=ϕ(1−|ϕ|), and with V_{C,u,i} is the sum of the voltages across primary side capacitors of the i^{th} stacked DAHB circuit, and V_{C,l,i} is the sum of the voltages across secondary side capacitors of the i^{th} stacked DAHB circuit.

The one or more processor-based devices configured to derive for each of the stacked DAHB circuits respective control values ζᵢ may be configured to derive control values ζᵢ that produce dynamically varying switching frequency, f_{sw,i} to maintain soft-switching performance of the respective stacked DAHB circuits.

The one or more processor-based devices configured to derive control values ζᵢ to maintain soft-switching performance of the respective stacked DAHB circuits may be configured to derive control values ζᵢ that produce the dynamically varying switching frequency, f_{sw,i}, in which |ϕᵢ| is set to greatest possible value for a particular allowable switching frequency range for f_{sw,i}.

The one or more processor-based devices configured to derive for each of the stacked DAHB circuits respective control values ζᵢ can be configured to derive for each of the stacked DAHB circuits respective control values ζᵢ to cause the stacked DAHB circuit to act as current sources.

In some variations, a DC/AC voltage inversion method is disclosed that includes measuring electrical properties of a voltage inversion system that includes multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side, and controlling, based on the measured electrical properties of the voltage inversion system, electrical operation of the multiple modular phase circuits.

Embodiments of the method may include at least some of the features described in the present disclosure, including at least some of the features described above in relation to the system, as well as one or more of the following features.

Controlling the electrical operation of the multiple modular phase circuits can include actuating one or more controllable switching devices included in each of the reconfigured stacked DAHB circuits of three modular phase circuits of the voltage inversion system to achieve a 3-phase grid voltage output.

Actuating the one or more controllable switching devices included in the reconfigured stacked DAHB circuits may include measuring, using sensor devices connected to output of the voltage inverter system, grid currents and output voltages produced by the multiple modular phase circuits and provided to the electrical grid determining, using a phase-locked-loop (PLL) device, the instantaneous phase, θ, of the electrical grid transforming, based at least on the determined instantaneous phase θ, the measured grid currents and output voltages into transformed grid currents and output voltages in a dq0 space, and deriving, based on the dq0 transformed grid currents and output voltages, switch actuation signals to actuate the one or more switching devices of the each of the reconfigured stacked DAHB circuits.

Deriving switch actuation signals may include deriving for each of the stacked DAHB circuits based on the dq0 transformed grid currents and output voltages, control values for control variable, ζᵢ, with i identifying the multiple modular phase circuits, to control electrical behavior of the respective stacked DAHB circuits, and determining, based on the control values for ζᵢ, switch frequencies, f_{sw,i}, control signals applied to respective switching devices of the each of the stacked DAHB circuits, and phase differences, ϕᵢ, between the respective control signals for each of the stacked DAHB circuits.

Deriving for each of the stacked DAHB circuits respective control values ζᵢ can include deriving control values ζᵢ that produce dynamically varying switching frequency, f_{sw,i} to maintain soft-switching performance of the respective stacked DAHB circuits.

In some variations, a non-transitory computer readable media is provided that includes computer instructions executable on a processor-based device to obtain measurements of electrical properties of a voltage inversion system that includes multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side, and control, based on the measured electrical properties of the voltage inversion system, electrical operation of the multiple modular phase circuits.

Embodiments of the computer readable media may include at least some of the features described in the present disclosure, including at least some of the features described above in relation to the system and method.

Other features and advantages of the invention are apparent from the following description, and from the claims.

### BRIEF DESCRIPTION OF THE DRAWINGS

These and other aspects will now be described in detail with reference to the following drawings.

FIG. 1 is a circuit diagram of a topology of an example three-phase inverter.

FIG. 2A is a circuit diagram showing the reconfiguration of a DAHB circuit into a stacked DAHB circuit topology.

FIG. 2B includes circuit schematic of the stacked DAHB circuit and a power transfer diagram for a functionally equivalent stacked capacitor circuit.

FIG. 3 includes graphs showing instantaneous grid parameters and their associated internal operating points for an example stacked DAHB over one cycle of the grid.

FIG. 4 is a graph showing operating points for a constant f_{sw} over one cycle of the grid for different grid currents, identifying the soft-switching region boundaries defined by the different curves.

FIG. 5 includes graphs illustrating behavior of the switching frequency f_{sw} and the normalized phase difference ϕ as a function of the normalized output current I_{o,n} for different values of f_{sw,max}.

FIG. 6 is a graph of the trajectories of both a variable f_{sw} and a constant f_{sw} schemes over one cycle of the grid in relation to the soft-switching boundaries of the DAHB.

FIG. 7 include frequency response graphs for an open loop bandwidth of a stacked DAHB circuit for various values of f_{sw}, C1-4, and grid inductance L_{g}.

FIG. 8 is a schematic diagram of an example control topology for an inverter implemented using stacked DAHB circuit modules.

FIG. 9 is a photograph of an example experimental prototype that was used to validate the proposed inverter framework.

FIG. 10A is a graph of a switching waveform for constant value of ϕ=0.3 and an output voltage Vₒ=200V.

FIG. 10B is a graph with switching waveform plots corresponding to two test conditions, both with ϕ=−0.4, but with different output voltages.

FIG. 11 includes plots of a three-phase grid current Iₒ, a voltage Vₒ, inductor current I_{Lk}, and DC link current I_{DC} for constant f_{sw} control with I_{d}=7 A and I_{q}=0 A.

FIG. 12 includes plots of a three-phase grid current Iₒ, and a voltage Vₒ, inductor current I_{Lk}, and DC link current I_{DC} for constant f_{sw} control with I_{d}=0 A and I_{q}=7 A.

FIG. 13 includes plots showing inductor current envelopes for I_{q}=−4 A and I_{q}=4 A.

FIG. 14 includes plots for three-phase grid current Iₒ, voltage Vₒ, inductor current I_{Lk}, and DC link current I_{DC} for constant f_{sw} control with a −5 to 5 A I_{d} step.

FIG. 15 includes plots for three-phase grid current Iₒ, voltage Vₒ, inductor current I_{Lk}, and DC link current I_{DC} for constant f_{sw} control with 0 to 7 A I_{q} step.

FIG. 16 is a graph with plots illustrating the efficiency and THD-F measurements of the proposed inverter operating under a constant f_{sw} scheme.

FIG. 17 includes plots for three-phase grid current Iₒ, voltage Vₒ, inductor current I_{Lk}, DC link voltage V_{DC}, and DC link current I_{DC} for variable f_{sw} control with a 14 to −14 A I_{q} step.

FIG. 18 includes plots for three-phase grid current Iₒ, voltage Vₒ, inductor current I_{Lk}, DC link voltage V_{DC}, and DC link current I_{DC} for variable f_{sw} control with a 14 to −14 A I_{d} step.

FIG. 19 includes plots of the three-phase grid current Iₒ, voltage Vₒ, inductor current I_{Lk}, and DC link voltage V_{DC} during a grid voltage sag of 17% of the nominal value.

FIG. 20 includes plots showing behavior of f_{sw}, ϕ, Io, and Vₒ as actuated and measured by a microcontroller over one cycle of the grid with I_{d} of 12 A.

FIG. 21 is a graph with plots illustrating the efficiency and grid current THD-F of the variable f_{sw} scheme over a range of output powers.

FIG. 22 is a flowchart of an example procedure for DC/AC voltage inversion.

Like reference symbols in the various drawings indicate like elements.

### DESCRIPTION

Disclosed are systems, methods, and other implementations (including hardware, software, and hybrid hardware/software implementations) directed to a multi-phase (e.g., three phases) partial-power-processing (PPP) inverter framework, where each phase of the AC grid is serviced by a stacked DAHB. Analysis of the stacked DAHB can be performed in the context of the Manhattan Topology, and the influence of the dynamic operating points over a cycle of the grid can be assessed. The PPP configuration of the stacked DAHB (in which some of the power is not processed by the converter) improves the overall efficiency, even as an AC interface, when compared with the efficiency of just the DAHB over these same operating points. In some embodiments, the PPP framework is implemented with provisions for maintaining soft-switching of the DAHB over the cycle of the grid using various control schemes. The proposed inverter implementations described herein provide high efficiency and high power density conversion that are useful for improving EV performance. The inverter implementations process internally less power than what they output. This allows for an increase in power density and efficiency and a decrease in the sizing of the power electronics hardware, which can reduce costs. Possible commercial uses for the DC/AC inverters described herein include applications such as consumer battery backups, solar inverters, and stationary electric vehicle chargers.

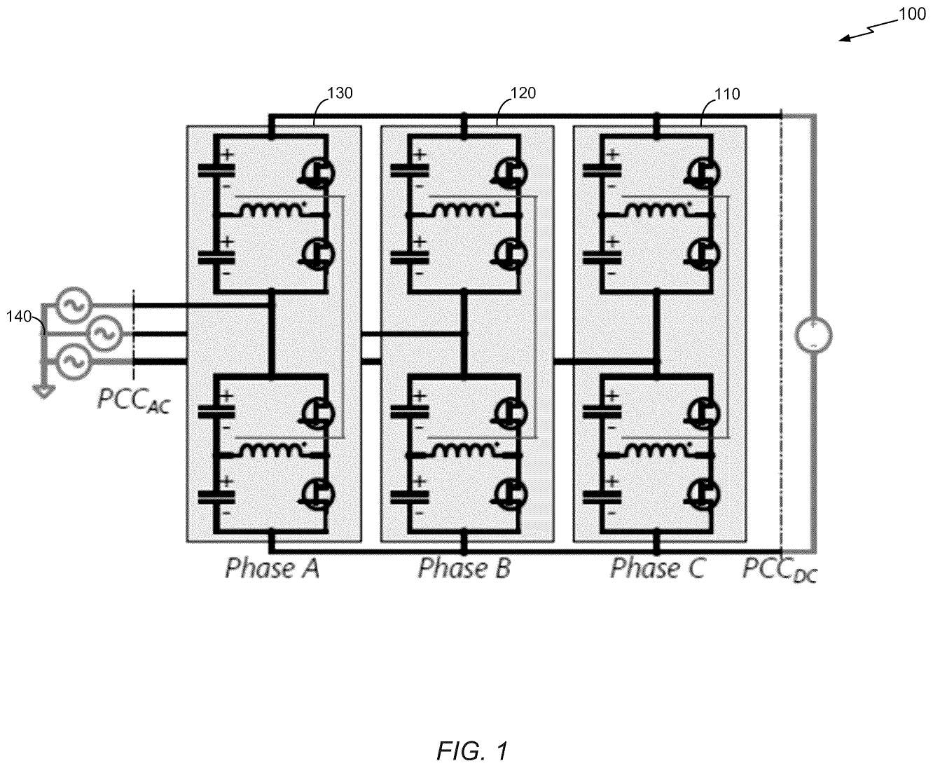

With reference to FIG. 1, a circuit diagram of a topology of an example three-phase inverter 100 (e.g., implemented as a partial power processing inverter) is shown The topology of the PPP 3-phase inventor is grid-tied and includes three phase modular units 110, 120, and 130 that operate together to interface with a three-phase grid 140. Each phase-modular unit is a stacked DAHB that can be analyzed and controlled independently. As noted, each stacked DAHB can be analyzed within the framework of the Manhattan configuration. Further details regarding the Manhattan configuration are provided in PCT publication WO 2023/244569, entitled “Systems and methods for power conversion using controllable converters,” the content of which is incorporate herein by reference in its entirety

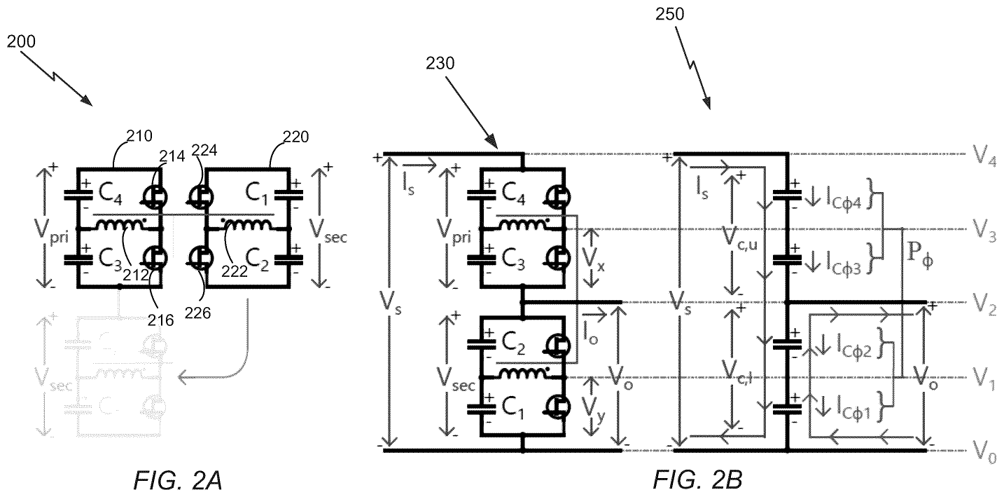

The analysis of the three-phase inverter of FIG. 1 begins by first re-drawing a DAHB circuit as a set of four stacked capacitors, as illustrated in the circuit schematic 200 of FIG. 2A, showing the reconfiguration of a DAHB circuit into a stacked DAHB circuit topology. As depicted in FIG. 2A, in the initial configuration of the DAHB circuit, the primary (left side) DAHB section 210 of the circuit is galvanically isolated from the secondary (right) DAHB section 220 using a transformer with primary windings 212 and secondary windings 222. The primary side further includes primary capacitors (also referred to as upper capacitors) C3 and C4. Electrical operation/behavior of the primary DAHB section 210 is controlled via respective switching devices 214 and 216 (e.g., FET transistors), which are actuated using one or more controllers (that may include processor-based controllers, not shown in FIGS. 2A or 2B). Similarly, the secondary DAHB section 220 includes two capacitors C1 and C2 that are electrically coupled to respective switching devices 224 and 226 (also actuated by the one or more controllers).

To convert the DAHB circuit of FIG. 2A into the reconfigured DAHB stacked representation, the bottom capacitors, C2 and C3 of each section half are electrically coupled to each other, resulting in the positive terminal of C2 being tied to the negative terminal of the capacitor C3. FIG. 2B is a circuit schematic of the stacked DAHB 230 (used in the proposed PPP three-phase inverter, such as the PPP three-phase inverter of FIG. 1) and a power transfer diagram 250 for a functionally equivalent stacked capacitor circuit. The circuit 230 results from the DAHB circuit reconfiguration illustrated in FIG. 2A. The diagram 250 illustrates the power transfer mechanism used to transfer power between the four capacitors of the diagram.

Thus, in various examples, implementations of the proposed voltage inversion system include multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side, and one or more controllers to control electrical operation of the multiple modular phase circuits. The reconfigured stacked DAHB circuits of the multiple modular phase circuits may be configured to perform partial power processing. For example, the reconfigured stacked DAHB circuits may be configured to have at least part of input power to the respective reconfigured stacked DAHB circuits bypass the galvanic isolations between the primary side and the secondary side of the respective reconfigured stacked DAHB circuits. In some embodiments, the multiple modular phase circuits may include three modular phase circuits.

In the example inverters 100 and 230 of FIGS. 1 and 2B, respectively, each reconfigured stacked DAHB circuit include a primary section with two primary capacitors arranged in series, two switching devices arranged in series, with the series arrangement of the two primary capacitors placed in parallel to the series arrangement of the two primary switching devices, and a primary inductive element connecting a common terminal of the two primary capacitors and a common terminal of the two primary switching devices. Such an example reconfigured stacked DAHB also includes a secondary section including two secondary capacitors arranged in series, two secondary switching devices arranged in series, with the series arrangement of the two secondary capacitors placed in parallel to the series arrangement of the two secondary switching devices, and a secondary inductive element connecting a common terminal of the two secondary capacitors to a common terminal of the two secondary switching devices. As illustrated in the circuits FIGS. 1 and 2B, a terminal of one of the two primary capacitors is electrically coupled to a terminal of one of two secondary capacitors, and the primary inductive element is inductively coupled to the secondary inductive element (the primary and secondary inductive elements, in some examples, form a transformer).

With continued reference to FIG. 2B, in diagram 250 the input voltage Vs is applied across all four capacitors C₁₋₄ between nodes V₄ and V₀. The output voltage Vo is taken at the center node between V₂ and V₀, across capacitors C1-2. Node V₄ and V₀ are the nodes of highest and lowest potentials, respectively, and can be considered as a DC link equivalent. The input and output nomenclatures are used for convenience as each stacked DAHB is capable of bidirectional power flow, which is a necessary condition for their AC application.

The main capacitive power transfer mechanism is denoted as P_{ϕ}. P_{ϕ} transfers power between the set of upper capacitors C3-4 and the set of lower capacitors C1-2. A non-zero value of P_{ϕ} is necessary to maintain capacitor voltage balance in steady-state for non-zero output power. This is established by analyzing the average currents through each individual capacitor during steady-state operation of the circuit of the diagram 250 as follows:

$${I}_{C 4} = {I}_{s} + {I}_{C ϕ4} \qquad Eq . 1$$

$${I}_{C 3} = {I}_{s} + {I}_{C ϕ3}$$

$${I}_{C 2} = {I}_{s} - {I}_{o} + {I}_{C ϕ2}$$

$${I}_{C 1} = {I}_{s} - {I}_{o} + {I}_{C ϕ 1} .$$

Here, Iₛ and Iₒ are the capacitor currents due to the externalities of the input and output currents, respectively. I_{Cϕ1-4} are the individual capacitor currents due to the capacitive power transfer mechanism.

Maintaining voltage balance in steady state requires the average current through each capacitor to be equal to zero. This is done by using the capacitive power transfer mechanism to set I_{Cϕ1-4} to values that cancel the capacitor currents due to Iₛ and Iₒ. Thus, the values of I_{Cϕ1-4} can be set such that:

$${I}_{C ϕ4} = {I}_{s} \qquad Eq . 2$$

$${I}_{C ϕ3} = {I}_{s}$$

$${I}_{C ϕ2} = {I}_{s} - {I}_{o}$$

$${I}_{C ϕ1} = {I}_{s} - {I}_{o} .$$

A similar analysis can be done in the power domain. The values for I_{Cϕ1-4} that need to be induced to maintain capacitor voltage balance in steady state can be considered as excess powers within C1-4 that need to be exchanged amongst each other as:

$${P}_{e , C 4} = {V}_{C 4} {I}_{s} , \qquad Eq . 3$$

$${P}_{e , C 3} = {V}_{C 3} {I}_{s} ,$$

$${P}_{e , C 2} = {V}_{C 2} ( {I}_{s} - {I}_{o} ) ,$$

$${P}_{e , C 1} = {V}_{C 1} ( {I}_{s} - {I}_{o} ) .$$

P_{e,C1-4} are found by taking the product of I_{Cϕ1-4} and its respective capacitor voltage. P_{e,C1-4} are then rearranged into the excess powers within the set of upper capacitors P_{e,u,}, that includes C3 and C4, and excess powers within the set of lower capacitors, P_{e,l}, that includes C1 and C2, as

$${P}_{e , u} = {I}_{s} ( {V}_{C 3} + {V}_{C 4} ) = {I}_{s} ( {V}_{s} - {V}_{o} ) , \qquad Eq . 4$$

$${P}_{e , l} = ( {I}_{s} - {I}_{o} ) ( {V}_{C 1} + {V}_{C 2} ) = ( {I}_{s} - {I}_{o} ) ( {V}_{o} ) .$$

When the constraint of conservation of energy Pₛ=Pₒ, explicitly written as VₛIₛ=VₒIₒ, is applied, the excess power equations provided above can be rearranged into the convenient result of P_{e,u}=P_{e,l}=P_{ϕ,ss}, where the amount of power that needs to be exchanged between the upper set of capacitors, P_{e,u}, and the lower set of capacitors P_{e,l} to maintain voltage balance in steady state is equal. This value is denoted as P_{ϕ,ss} and is useful in the context of the DAHB capacitive power transfer mechanism as this is equivalent to the power required to be transferred over the inductive coupling.

The first noteworthy observation of the internal power transfer between capacitors is that P_{ϕ,ss} is always less than the output power Pₒ. The relationship between P_{ϕ,ss} and Pₒ is a function of the voltage conversion ratio, namely:

$$\frac{{P}_{ϕ , ss}}{{P}_{o}} = \frac{{V}_{s} - {V}_{o}}{{V}_{s}} = \frac{{I}_{s} - {I}_{o}}{{I}_{s}} . \qquad Eq . 5$$

For all allowable voltage conversion ratios, where Vₒ<Vₛ, P_{ϕ,ss} will always be less than Pₒ. The second noteworthy observation of the internal power transfer between capacitors is that it is not necessary to move power within the set of upper capacitors (C3 to/from C4) or within the set of lower capacitors (C1 to/from C2) for a given output voltage and current condition. It is only necessary to move power between the set of upper capacitors and the set of lower capacitors (C1-2 to/from C3-4). This is convenient as it allows for a relatively simple control methodology. It also allows for the grouping of the upper capacitors and lower capacitors into their respective sets which can simplify design and analysis.

The capacitive power transfer mechanism for each module is made of a single DAHB where the primary side services the set of upper capacitors C3-4 and the secondary side the set of lower capacitors C1-2. The required power transfer to maintain capacitor voltage balance in steady state P_{ϕ,ss} is implemented by transferring power across the inductive coupling of the DAHB. This allows for the exchange of power between the set of upper capacitors and the set of lower capacitors. The power transferred across the inductive coupling P_{ϕ} can be described according to:

$${P}_{ϕ} = {KV}_{C , u} {V}_{C , l} ζ , \qquad Eq . 6$$

$$K = \frac{{N}_{p}}{{N}_{s} 8 {f}_{sw} {L}_{Lk}} , and$$

$$ζ = ϕ ( 1 - \vert ϕ \vert ) ,$$

where V_{C,u} is the sum of the voltages across the upper capacitors (C3-4) and can be considered the voltage of the primary side of the DAHB, and V_{C,l} is the sum of the voltages across the lower capacitors (C1-2) and can be considered the voltage of the secondary side of the DAHB. ϕ is the phase difference between switching cycles of the primary and secondary sides of the DAHB, normalized to one-half the switching period. f_{sw} is the switching frequency, and L_{Lk}, Nₚ and Nₛ are the leakage inductance, primary turns number, and secondary turns number, respectively, of the DAHB transformer. It is assumed that Nₚ and Nₛ are always equal for a unity voltage transformation. The above equations for the power transferred across the inductive coupling (i.e., P_{ϕ}) can be rearranged into a single equation, which is the typical approach for DAHB analysis. However, the representation of P_{ϕ} can be separated for both readability and to preserve a linear relationship between P_{ϕ} and ζ. Maintaining this relationship as linear simplifies control design. ζ is ultimately the term that is used to control Pϕ. For the proposed topology the duty cycles of both the primary and secondary sides of the DAHB are considered to be set to a static value of 0.5. The capacitance values are set to always be equal, with C=C1=C2=C3=C4. This has the implication that the capacitor voltages and DAHB balancing currents on each side of the DAHB are equal, explicitly written as V_{C1}=V_{C2}, I_{Cϕ1}=I_{Cϕ2}, V_{C3}=V_{C4}, and I_{Cϕ3}=I_{Cϕ4}. The individual capacitor currents due to the DAHB capacitive power transfer scheme can then be found as:

$${I}_{C ϕ1} = {I}_{C ϕ2} = K ( {V}_{C 3} + {V}_{C 4} ) ζ , \qquad Eq . 7$$

$${I}_{C ϕ3} = {I}_{C ϕ4} = K ( {V}_{C 1} + {V}_{C 2} ) ( - ζ ) .$$

The total capacitor currents, including the currents due to the externalities Iₛ and Iₒ, are then I_{C1}=I_{C2}=K(V_{C3}+V_{C4})ζ+Iₛ−Iₒ, and I_{C3}=I_{C4}=K(V_{C1}+V_{C2})(−ζ)+Iₛ. The dynamic equations for the four capacitor voltages can then be found considering C(dV_{c}/dt)=I_{c}, resulting in:

$$\frac{{dV}_{C 1}}{dt} = \frac{{dV}_{C 2}}{dt} = \frac{1}{C} K ( {V}_{C 3} + {V}_{C 4} ) ζ + \frac{1}{C} ( {I}_{s} - {I}_{o} ) , and \qquad Eq . 8$$

$$\frac{{dV}_{C 3}}{dt} = \frac{{dV}_{C 4}}{dt} = \frac{1}{C} K ( {V}_{C 1} + {V}_{C 2} ) ( - ζ ) + \frac{1}{C} {I}_{s} .$$

As noted above, the capacitor currents due to the capacitive power transfer mechanisms must cancel the capacitor currents due to externalities Iₛ and Iₒ. When this condition is achieved, the values for dV_{C1-4}/dt become zero. Iₛ and Iₒ are determined by the load condition and voltage conversion ratio and are therefore not controlled. Instead, ζ can be controlled to a value such that Iₛ and Iₒ are cancelled where P_{ϕ}=P_{ϕ,ss}. When this is the case, the relationship between ζ and Iₒ becomes Iₒ=ζKVₛ.

Notably, the output current Iₒ has no dependency on the output voltage Vₒ, instead only depending on the input voltage Vₛ, DAHB circuit parameters K, and control variable ζ. The output of each phase-modular stacked DAHB acts as a current source, and when multiple are configured together as an AC interface, they act as a quasi-current-source inverter. This is convenient for grid-following applications where the grid voltage is defined and the role of the inverter is to only provide current.

Implementations of the stacked DAHB as AC interfaces are next described. The operating points that each stacked DAHB module traverses over one cycle of the grid can have significant variation. It is necessary to understand the range of operating points for component dimensioning. First the output voltage Vₒ and current Iₒ of the stacked DAHB interfaced with a single phase of the grid can be defined as

$${V}_{o} ( θ ) = \frac{{V}_{SC}}{2} + \sqrt{2} {V}_{grid} sin ( θ ) , \qquad Eq . 9$$

$${I}_{o} ( θ ) = {I}_{grid} sin ( θ - β ) ,$$

where V_{grid} is the RMS value of the line-to-neutral grid voltage and I_{grid} is the peak value of the line current. V_{DC} is the DC link voltage (equivalent to Vₛ in the previous analysis) and is considered to be a static value. It is assumed that the output voltage Vₒ averaged over one cycle of the grid, when referenced to the negative DC-link, is one-half the DC-link voltage. This is represented by the DC offset of V_{DC}/2. β is the phase difference between the grid current and voltage, and θ is the instantaneous value of the phase of the grid. In the context of this analysis, θ is swept with discrete values between 0≤θ≤2π (one cycle of the grid). Each discrete value of θ can be considered a quasi-steady-state operating point as the converter's switching frequency is much greater than the grid frequency.

Vₒ(θ) and/or Iₒ(θ) with a static value of V_{DC} can be substituted into Eq. 1 to give the required P_{ϕ,ss} over one cycle of the grid as

$${P}_{ϕ , ss} = {P}_{o} ( θ ) \frac{{V}_{DC} - {V}_{o} ( θ )}{{V}_{DC}} , \qquad Eq . 10$$

where Pₒ(θ) is the instantaneous output power of one phase of the stacked DAHB modules and is equivalent to Pₒ(θ)=Iₒ(θ)Vₒ(θ). When averaged over the cycle of the grid, the ratio of P_{ϕ}/Pₒ is equal to ½. This is true for all DC link voltages, grid voltages, and power levels, as long as the average grid voltage is equal to ½ the DC link voltage (written as the V_{DC}/2). In some applications it may be advantageous to shift the average grid voltage from V_{DC}/2 to another value, and for these applications the ratio of averaged processed power to output power P_{ϕ}/Pₒ will be equal to 1−V₀/V_{DC}, where V₀ is the average grid voltage.

Given the two equation sets for P_{ϕ} provided by Eq. 6 and Eq. 10, and the requirement of P_{ϕ}=P_{ϕ,ss}, the anticipated value of ζ(θ) given ideal circuit operation can be determined over one cycle of the grid as:

$$ζ ( θ ) = {I}_{o} ( θ ) K / {V}_{DC} , \qquad Eq . 11$$

where ζ(θ) is dependent on K (the DAHB parameters, which, as noted above, is computed according to

$$K = \frac{{N}_{p}}{{N}_{s} 8 {f}_{sw} {L}_{Lk}} ) ,$$

but is not dependent on the output voltage Vₒ(θ), supporting the usefulness of the stacked DAHB topology in grid-based applications.

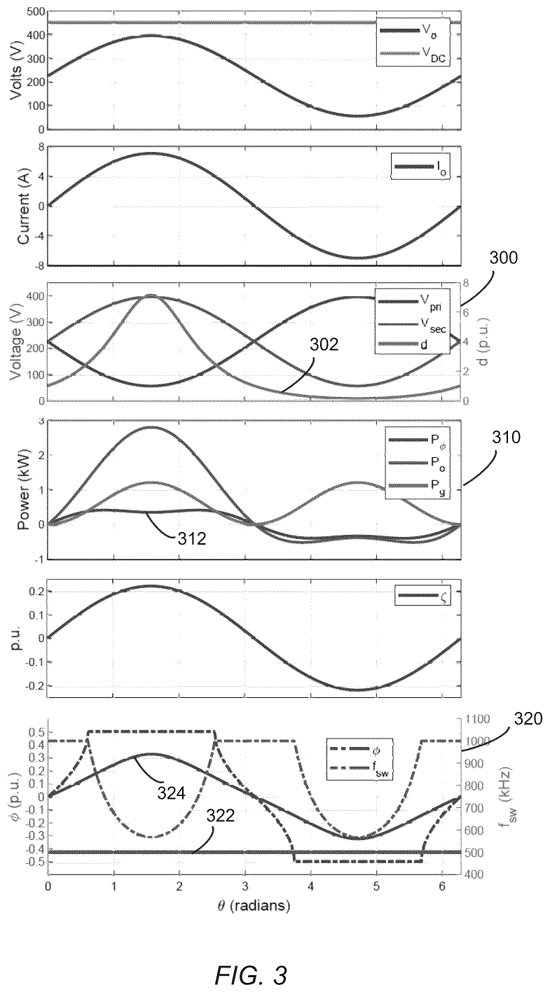

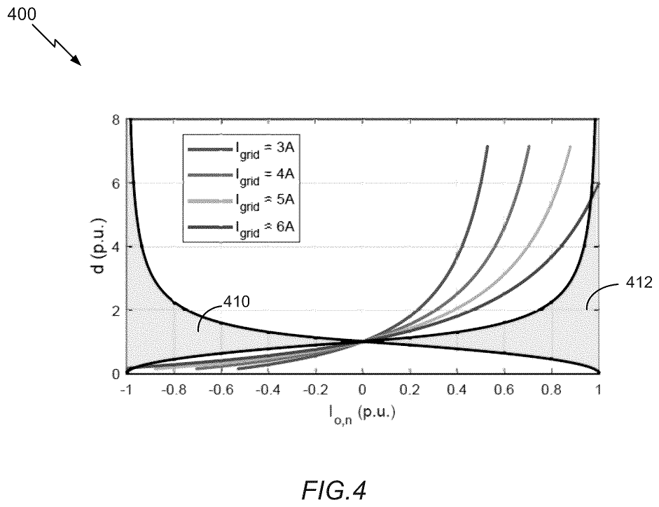

FIG. 3 includes graphs showing the instantaneous grid parameters and their associated internal operating points for a stacked DAHB over one cycle of the grid. Parameters of the stacked DAHB unit include L_{Lk}=3.5 μH (the leakage inductance), V_{grid}=120Vₗ₋ₙ, I_{grid}=5.7 A_{RMS}, and V_{DC}=450V. As can be seen from graph 300, the DAHB primary to secondary voltage ratio, d (illustrated by the curve 302), varies between extremes over the cycle of the grid. This is undesirable operation for DAHBs because deviating from a unity ratio (after the voltage transformation of the transformer turns ratio is applied) will result in excessively high currents and potential departure from the soft-switching region. The soft-switching boundaries of ϕ, as a function of ϕ and d for a DAHB under ideal operating conditions can be defined as,

$$1 - 2 \vert ϕ \vert < \frac{{V}_{sec}}{{V}_{pri}} < \frac{1}{1 - 2 \vert ϕ \vert} , \qquad Eq . 12$$

where the leftmost portion of the inequality represents the soft-switching boundary for the primary side switches, and the rightmost represents the boundary for the secondary side switches. This soft-switching region can be visualized in FIG. 4, which is a graph 400 showing operating points for a constant f_{sw} DAHB over one cycle of the grid for different grid currents, illustrating the DAHB soft-switching boundaries (gray shaded regions 410 and 412). The same DAHB parameters used to generate the graphs of FIG. 3 are used here. The DAHB parameters include I_{o,n}, which is Iₒ normalized to the maximum allowable output current the stacked DAHB can provide before it saturates. It can be seen that this constant f_{sw} stacked DAHB always operates outside of the soft-switching region aside from the relatively small portion of the grid cycle when the primary and secondary voltages are equal. Soft-switching has many benefits, such as lower semiconductor stresses, reduced switching losses, and improved Electromagnetic Interference (EMI) performance, and it is therefore advantageous to maintain the ability to soft-switch (if desired). Maintaining soft-switching over the grid cycle (e.g., remaining in the soft-switching region) can be achieved by making the switching frequency of the DAHB dynamic, as will be discussed below.

Turning back to FIG. 3, graph 310 illustrates the power behavior of the stacked DAHB unit along one cycle of the grid. Thy curve 312 corresponds to P_{g}, which is the instantaneous power provided to the grid by a single phase of the inverter. ζ of the constant f_{sw} scheme is equivalent to ζ′f_{sw} of the variable frequency scheme. In the bottom plot 320, solid lines used for curves 322 and 324 represent values corresponding to the constant f_{sw} scheme, while dashed lines represent values corresponding to the variable f_{sw} scheme.

As noted, in some embodiments, it is desirable to maintain soft-switching over the entire grid cycle. One approach for maintaining soft-switching over the entire grid cycle is by implementing dynamic switching frequency for the stacked DAHB (i.e., controlling a variable f_{sw} applied to the switching devices of the stacked DAHB topology to cause soft-switching to be maintained). In some embodiments, soft-switching can be maintained for all values of primary to secondary voltage ratio, d, if ϕ (the normalized phase difference between the primary and secondary sections of the DAHB), is held at a static value of either 0.5 or −0.5. For values of |ϕ|≤0.5, the allowable region of d for maintaining soft-switching decreases. It is important to note that circuit non-idealities will affect the soft-switching region. The effective drain-source capacitance of the FETs will shrink the soft-switching region. Decreasing the magnetization inductance L_{mag} to leakage inductance L_{Lk} ratio will expand the soft-switching region. These effects can be used to dimension the transformer. For a generalized approach, it is advantageous to keep ϕ as close as possible to its extremes of ±0.5 to maintain the widest soft-switching bounds over the cycle of the grid. This can be done by adjusting the switching frequency f_{sw} to achieve the desired value of P_{ϕ} while keeping ϕ at or as close as possible to its extremes of ±0.5. This variable frequency scheme represented using P_{ϕ}, K, and ζ (per the relationships of Eq. 6) to reflect that f_{sw} is dynamic, namely,

$${P}_{ϕ} = K ’ {V}_{C , u} {V}_{C , l} ζ ’ , \qquad Eq . 13$$

$${K}^{′} = \frac{{N}_{p}}{{N}_{s} 8 {L}_{Lk}} , and$$

$${ζ}^{′} ’ = ϕ ( 1 - \vert ϕ \vert ) / {f}_{sw} ,$$

by removing f_{sw} from the K term and inserting it into the ζ term to get K′ and ζ′. The ′ symbol denotes parameters of the variable frequency environment. It can be seen that there exists a range of combinations of f_{sw} and ϕ that will produce a single value of ζ′. However, not all combinations of f_{sw} and ϕ for a given value of ζ′ and d will be inside the soft-switching region.

As noted, one way to stay within the soft-switching region is to operate at the greatest possible value of |ϕ| (where ϕ≤0.5) for a given allowable switching frequency range. Mathematically, this can be expressed as:

$${f}_{sw} = \{ \begin{matrix}{f}_{sw , max} & for \vert {ζ}^{′} \vert \leq {{ζ}^{′}}_{x} \\ ( {ϕ}_{max} ( 1 - {ϕ}_{max} ) / \vert {ζ}^{′} \vert & for {{ζ}^{′}}_{x} < \vert {ζ}^{′} \vert < {{ζ}^{′}}_{y} \\ {f}_{sw , min} & for \vert {ζ}^{′} \vert \geq {{ζ}^{′}}_{y}\end{matrix} \qquad Eq . 13$$

$$ϕ = \{ \begin{matrix}- {ϕ}_{max} & for {ζ}^{′} \leq - {{ζ}^{′}}_{x} \\ ( 1 - \sqrt{1 - {4}_{sw , max} {ζ}^{′}} / 2 ) & for 0 \leq {ζ}^{′} \leq {{ζ}^{′}}_{x} \\ ( - 1 + \sqrt{1 + 4 {f}_{sw , max} {ζ}^{′}} / 2 ) & for - {{ζ}^{′}}_{x} \leq {ζ}^{′} \leq 0 \\ {ϕ}_{max} & for {ζ}^{′} \geq {{ζ}^{′}}_{x}\end{matrix} \qquad Eq . 14$$

where ζ′ₓ and ζ′_{y} are crossover points that define regions of constant or variable ϕ and f_{sw}, expressed as,

$${{ζ}^{′}}_{x} = \frac{( {ϕ}_{max} ( 1 - {ϕ}_{max} ) )}{{f}_{sw , max}} , and \qquad Eq . 15$$

$${{ζ}^{′}}_{y} = \frac{( {ϕ}_{max} ( 1 - {ϕ}_{max} ) )}{{f}_{sw , min}} .$$

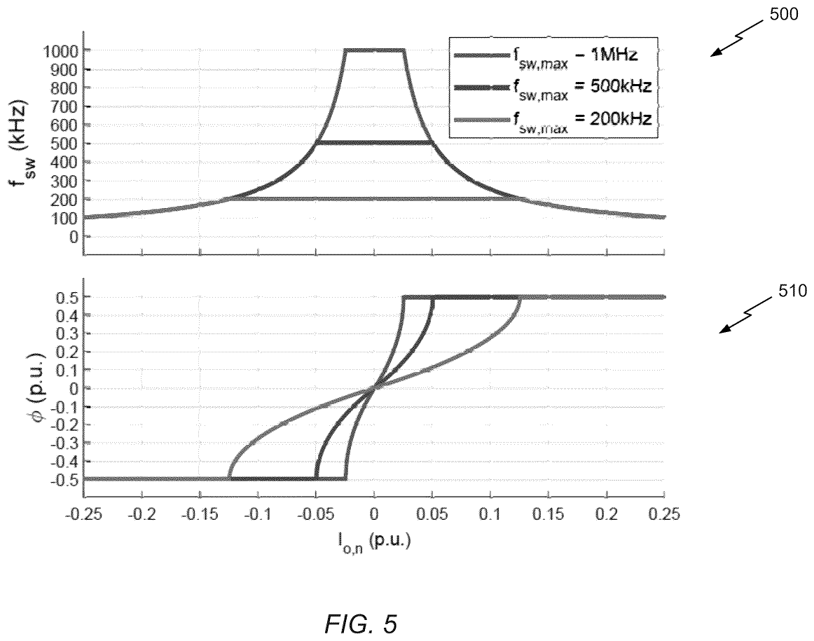

The term ϕₘₐₓ should be held at its maximum allowable value of 0.5 but is presented symbolically for reference. The term f_{sw,min} and f_{sw,max} are the minimum and maximum allowable switching frequencies, respectively, and are hardware-defined parameters. Values of ζ′ beyond ζ′≥ζ′_{y} represent an area of operation where the output power of the stacked DAHB is saturated and these values of ζ′ cannot be actuated. FIG. 5 provides a visualization of the values covered by the expressions of Eqs. 13-15, illustrating the switching frequency f_{sw} (in graph 500) and the normalized phase difference ϕ (in graph 510) as a function of the normalized output current I_{o,n} for different values of f_{sw,max}. The graphs 500 indicate the points where ϕ and f_{sw} are saturated at their respective limits as a function of ζ′.

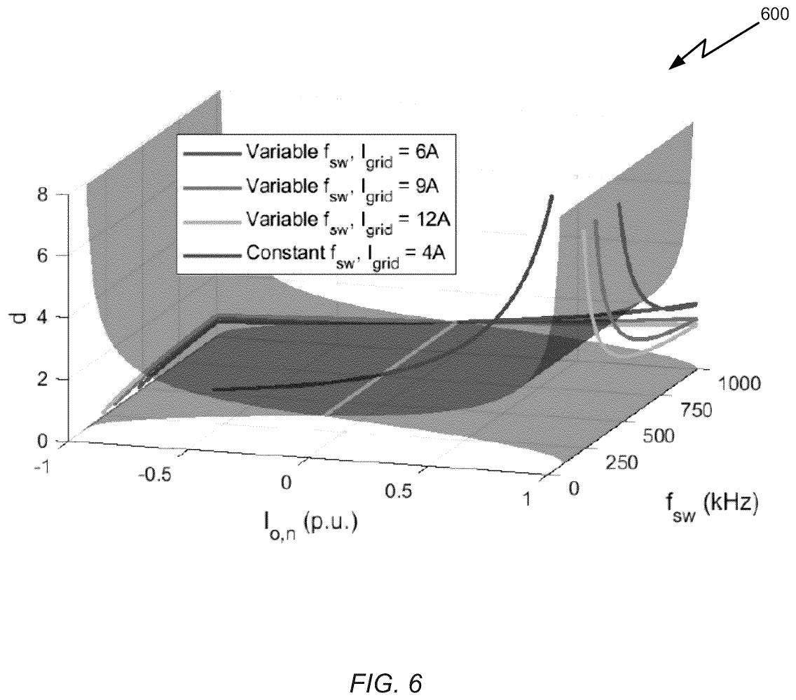

As discussed above, the graph 320 of FIG. 3 shows the values of ϕ and f_{sw} over one cycle of the grid for a hypothetical DAHB with f_{sw,max}=1 MHz. FIG. 6 is a graph 600 showing the trajectories of both the variable f_{sw} and constant f_{sw} schemes over one cycle of the grid as they relate to the soft-switching boundaries of the DAHB. The soft-switching region is between the two black planes. FIG. 6 illustrates that operation within the soft-switching region can be maintained over this grouping of power levels when interfacing the stacked DAHB with an AC grid. As discussed in greater detail below, a closed-loop control scheme can be used to interface with the AC grid for both a variable frequency and constant frequency approaches.

A few design considerations should be taken into account when implementing the stacked DAHB circuit. An important component affecting the performance of the stacked DAHB module is the transformer. Specifically, the leakage inductance-switching frequency product fsw·L_{Lk} determines the range of power, P_{ϕ}, that can be transferred over the inductive coupling in accordance with the relationships described in Eq. 6. There is a direct relationship between P_{ϕ} and the output power Pₒ of a stacked DAHB. The minimum fsw·L_{Lk} product required for a given maximum output current I_{o,max} is provided according to:

$${f}_{sw} \cdot {L}_{Lk} = \frac{{N}_{p} {V}_{DC}}{8 {N}_{s} {I}_{o , max}} . \qquad Eq . 16$$

Notably, the grid voltage does not influence the dimensioning of the fsw·L_{Lk} product. The individual values of f_{sw} and L_{Lk} can then be found given the converter's practical hardware limitations.

The second set of components that needs to be dimensioned is the set of DAHB capacitors (C1-4 in FIGS. 2A-B). The capacitors are first responsible for absorbing the leakage inductance current ripple I_{Lk} and can be sized for this role using various DAHB design and implementation techniques. In various embodiments, these capacitors also get charged and discharged with the varying output voltage Vₒ over the cycle of the grid. This has implications on the frequency response of the converter, as described in the

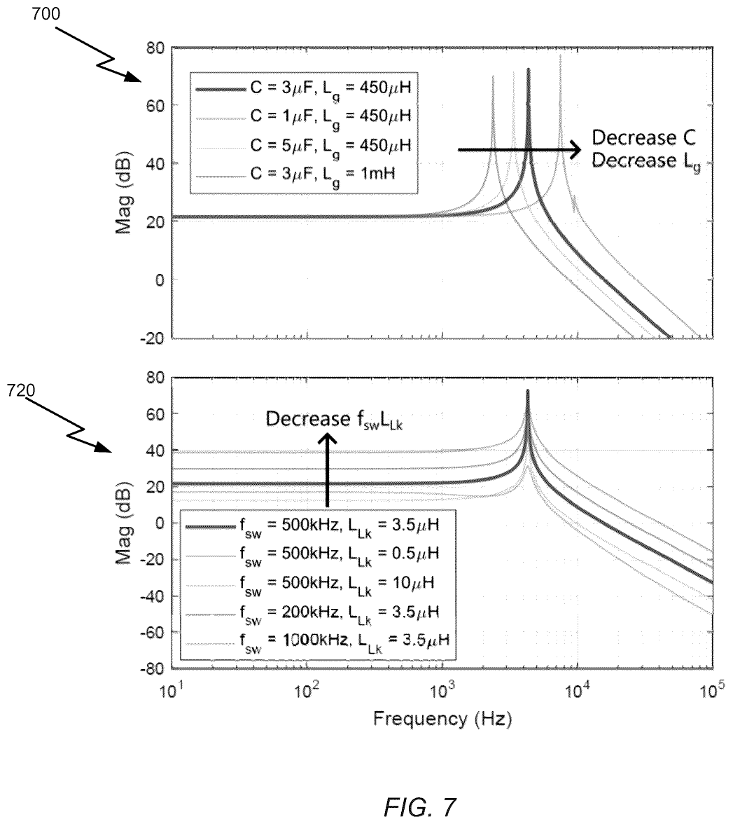

The frequency response represents another implementation consideration for the stacked DAHB circuit. Both the fsw·L_{Lk} product and capacitances C1-4 have significant effects on shaping the open loop bandwidth of the converter. The open loop bandwidth is found using a transfer defined as Iₒ/ζ. For this grid-following inverter application, ζ is the input control variable and the current Iₒ is the output. The frequency responses are found using a PLECS simulation and are presented in FIG. 7. The fsw·L_{Lk} product determines P_{ϕ} as a function of ζ. For a given value of ζ, a lower fsw·L_{Lk} product results in higher Iₒ and vice-versa. Therefore, a lower fsw·L_{Lk} product will increase the open-loop gain and a higher fsw·L_{Lk} product will decrease the open-loop gain. This can be seen in FIG. 7 where the fsw·L_{Lk} product is varied and the open-loop bandwidth measured. It can be seen that the converter exhibits a frequency response similar to that of an LC filter and that the fsw·L_{Lk} product only changes the overall gain and does not affect the cutoff frequency. The cutoff frequency is largely a function of the impedance of the grid and the capacitance C1-4 value. This is also shown in FIG. 7 where both the value of C1-4 and the grid impedance are varied while the fsw·L_{Lk} product is held constant. It can be seen that increasing the value of C1-4 and/or the inductance of the grid L_{g} lowers the cutoff frequency, which is in line with the frequency response of an LC filter. As it is not practically feasible to control the impedance of the grid, the only method for controlling the cutoff frequency is through the value of C1-4.

The analysis presented assumes that C1-4 all have equal values and that the L_{Lk} of the transformer for each stacked DAHB module is equal. In practical implementations component mismatch is to be expected and it is important to understand how it can impact the converter's performance. As noted, the capacitance values (if sufficiently sized according to the above guidelines) do not affect the steady state performance of the converter. Instead, they affect the transient performance of the converter, specifically, during transient steps in the output voltage. Equation 8 can be modified for the case of C1≠C2≠C3≠C4 according to:

$$\frac{{dV}_{C 1}}{dt} = \frac{1}{C 1} K ( {V}_{C 3} + {V}_{C 4} ) ζ + \frac{1}{C} ( {I}_{s} - {I}_{o} ) , \qquad Eq . 17$$

$$\frac{{dV}_{C 2}}{dt} = \frac{1}{C 2} K ( {V}_{C 3} + {V}_{C 4} ) ζ + \frac{1}{C} ( {I}_{s} - {I}_{o} ) ,$$

$$\frac{{dV}_{C 3}}{dt} = \frac{1}{C 3} K ( {V}_{C 1} + {V}_{C 2} ) ( - ζ ) + \frac{1}{C} {I}_{s} , and$$

$$\frac{{dV}_{C 4}}{dt} = \frac{1}{C 4} K ( {V}_{C 1} + {V}_{C 2} ) ( - ζ ) + \frac{1}{C} {I}_{s} .$$

It can be seen that larger capacitors will charge more slowly than smaller capacitors and vice-versa, and this will cause a degree of voltage level mismatch during the transient state that scales with the mismatch in capacitance values. Mismatch in L_{Lk} values between stacked DAHB modules manifests as different relationships between ζ and Iₒ for different modules according to Eq. 6. Errors in the Iₒ of each module represent an additional burden for the controllers controlling the electric behavior of the multi-phase inverters described herein, in particular the zero-sequence controller, and the tolerance to mismatch of L_{Lk} values will be set by the controllers' ability to compensate for these mismatches.

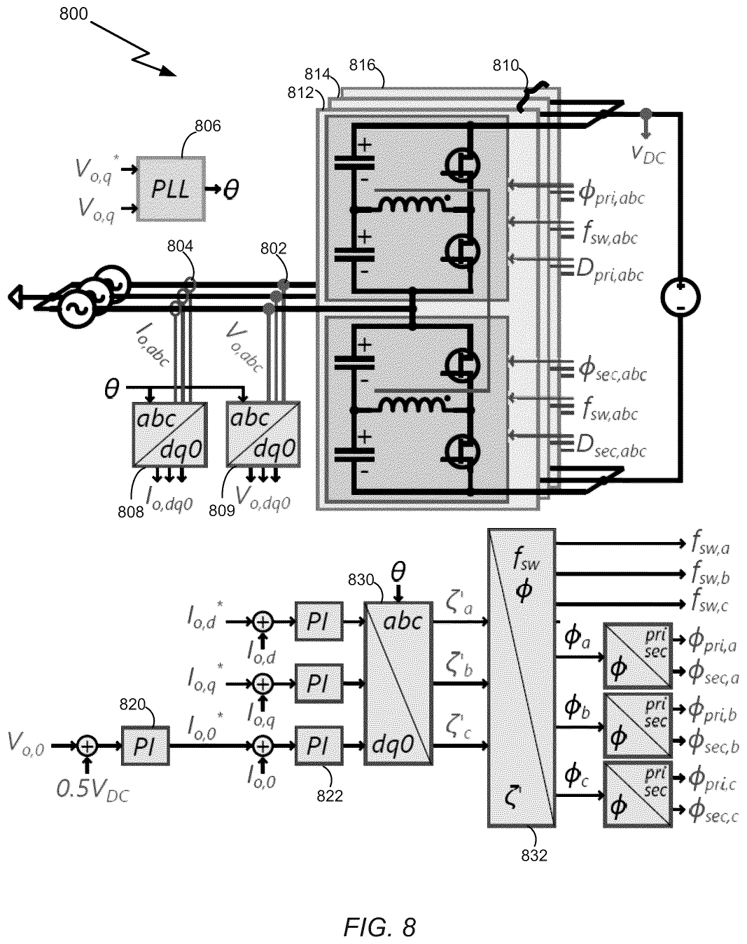

Turning next to control implementations that may be used for the stacked DAHB inverter described herein, FIG. 8 includes schematic diagram 800 of an example control topology that can be implemented. Under the proposed control implementation, the three-phase grid current I_{o,abc}, three-phase output voltages V_{o,abc} produced by a three-phase stacked DAHB inverter 810 (which may be similar to the inverter 100 of FIG. 1), and the DC link voltage V_{DC}, are measure by sensor/measurement devices such as, for example, ampermeters and voltmeters, for measuring electrical characteristics of components of the inverter 800. For simplicity, only one voltmeter 802, and only one ampermeter 804 are shown, but additional measurement devices may be required for each electrical output of the three stacked DAHB circuits 812, 814, and 816 depicted in FIG. 8. Generally, all voltages are measured with respect to the negative DC link. As this is a grid-following converter, the parameters that the controller actuates are the three-phase grid currents. First, a phase-locked-loop (PLL), such as PLL 806, provides the value of the instantaneous phase θ of the grid. This allows for the three-phase grid and voltage measurements to be transformed from the abc to the dq0 spaces (e.g., using transformer modules 808 and 809, which can be dedicated processor-based modules, or implemented on one or more distributed computing devices, configured to apply Park transformations to quantities measured or computed in the abc reference frame). The measured zero voltage V_{o,0} is used in an outer controller 820 (a proportional-Integral, or PI, controller) to provide the reference zero-current

$${I}_{o , 0}^{*}$$

that an inner PI controller 822 tries to actuate to achieve a zero-voltage equal to one-half the DC link voltage. The reference d and q currents,

$${I}_{o , d}^{*} and {I}_{o , q}^{*} ,$$

respectively, are manually set. Similar control schemes may also use an additional outer-loop controller (e.g., a PI controller), to set

$${I}_{o , d}^{*}$$

to achieve a desired DC link voltage. For the proposed implementations, the DC-link voltage is considered to be set by an external DC source and thus such an additional outer-loop controller is not included.

The inner-loop of the controller includes two additional individual controllers (e.g., PI controllers) 824 and 826, one for each component of the grid current in the dq0 space. The output of the I_{dq0} PI controllers 822, 824, and 826 are passed through an inverse Park transformation 830 to give values of ζ′ (which are related to the phase difference between the primary and secondary switching frequency of each stacked DAHB) in the abc reference frame. These values of

$${ζ}_{abc}^{′}$$

are then converted (e.g., using a conversion unit 832) into values or control signals representing ϕ_{abc} and f_{sw,abc} that are used to actuate the hardware of the inverter 810 (e.g., the switching devices of the various stacked DAHB units). For the variable frequency case,

$${ζ}_{abc}^{′}$$

is converted into values of f_{sw,abc} and ϕ_{abc}. The constant f_{sw} case uses these same equations but the bounds of f_{sw} are set such that f_{sw,min}=f_{sw,max}=f_{sw,constant}.

Practical controllers cannot implement negative values of ϕ. Positive values of ϕ correspond to phase delay of the secondary side of the DAHB. Negative values of ϕ correspond to a phase delay of the primary side of the DAHB. This can be written as:

$${ϕ}_{pri} = \{ \begin{matrix}0 & for ϕ > 0 \\ ϕ & for ϕ \leq 0\end{matrix}$$

$${ϕ}_{sec} = \{ \begin{matrix}ϕ & for ϕ > 0 \\ 0 & for ϕ \leq 0\end{matrix}$$

where ϕₚᵣᵢ and ϕ_{sec}, the individual phase delays for the primary and secondary sides of the DAHB, respectively, can be practically actuated. The terms, D_{pri,abc} and D_{sec,abc}, are the duty cycles in the abc frame of the primary and secondary sides and are set to a static value of 0.5.

Accordingly, in various example implementations of the voltage inverter system, each of the reconfigured stacked DAHB circuits includes one or more controllable switching devices, and the one or more controllers (e.g., to control the switching devices used in the stacked DAHB circuits) include, for example, sensor devices, connected to the output of the voltage inverter system, to measure grid currents and output voltages produced by the multiple modular phase circuits, a phase-locked-loop (PLL) device to determine the instantaneous phase, θ, of the electrical grid, and one or more processor-based devices. The one or more processor-based devices are configured to transform, based at least on the determined instantaneous phase θ, the measured grid currents and output voltages into transformed grid current and output voltages in a dq0 space, and derive based on the dq0 transformed grid currents and output voltages switch actuation signals to actuate the one or more controllable switching devices of the each reconfigured stacked DAHB circuit. The one or more processor-based devices configured to derive switch actuation signals are configured to derive for each of the stacked DAHB circuits, from the respective multiple modular phase circuits, based on the dq0 transformed grid currents and output voltages, control values for control variable, ζᵢ, with i identifying the multiple modular phase circuits, to control electrical behavior of the respective stacked DAHB circuits, and determine, based on the control values for ζᵢ, switch frequencies, f_{sw,i}, of control signals applied to respective switching devices of the each of the stacked DAHB circuits, and phase differences, ϕᵢ, between the control signals for each of the stacked DAHB circuits. It is noted that a controller can be a distributed controller, in which various components (e.g., sensors, PLL, processor-based devices) are deployed at various points of the inverter system circuit, but with some of the various components being able to communicate (through wired or wireless mechanisms) with other components (e.g., sensors and PLL communicating with the processor-based devices).

In some embodiments, the control values ζᵢ are each related to the power transferred across respective inductive couplings of the stacked DAHB circuits according to P_{ϕ,i}=KᵢV_{C,u,i}V_{C,l,i}ζᵢ, with

$${K}_{i} = \frac{{N}_{p , i}}{{N}_{s , i} 8 {f}_{sw , i} {L}_{Lk , i}} ,$$

with ζ=ϕ(1−|ϕ|), and with V_{C,u,i} is the sum of the voltages across primary side capacitors of the i^{th} stacked DAHB circuit, and V_{C,l,i} being the sum of the voltages across secondary side capacitors of the i^{th} stacked DAHB circuit. The one or more processor-based devices configured to derive for each of the stacked DAHB circuits respective control values ζᵢ may be configured to derive control values ζᵢ that produce dynamically varying switching frequency, f_{sw,i} to maintain soft-switching performance of the respective stacked DAHB circuits. The one or more processor-based devices configured to derive control values ζᵢ to maintain soft-switching performance of the respective stacked DAHB circuits can be configured to derive control values ζᵢ that produce the dynamically varying switching frequency, f_{sw,i}, in which |ϕᵢ| is set to greatest possible value for a particular allowable switching frequency range for f_{sw,i}. In some examples, the one or more processor-based devices configured to derive for each of the stacked DAHB circuits respective control values ζᵢ may be configured to derive for each of the stacked DAHB circuits respective control values ζᵢ to cause the stacked DAHB circuit to act as current sources.

In some embodiments, the one or more controllers configured to control electrical operation of the multiple modular phase circuits can be configured to perform one of, for example, maintain a soft switching operations (e.g., through implementations that vary the switching frequency) for switching devices coupled to capacitors of the respective reconfigured stacked DAHB circuits, or maintain substantially constant switching frequencies for the respective reconfigured stacked DAHB circuits.

The proposed three-phase stacked DAHB inverter is compared to other types of converters/inverters with respect to hardware, control, and performance characteristics in grid-tied/grid-following applications. A comparison in component quantities of the proposed inverter to a traditional 2-level, T-type, and 3-level Neutral-Point-Clamped (NPC) 3-phase inverter topologies is provided in Table I below. These quantities consider the 2-level, T-type, and NPC topologies to all have an additional LC filter at the grid connection. In contrast, the proposed topology does not need this additional LC filter since the output at the grid connection is already filtered by the leakage inductance L_{Lk} and capacitances C1-4.

TABLE I
Component Quantity Comparison

| Topology | Magnetics | Capacitors | Semiconductors |
|---|---|---|---|
| 2-level | 3 | 4 | 6 |
| T-type | 3 | 9 | 18 |
| 3-level NPC | 3 | 9 | 18 |
| Proposed stacked | 3 | 12 | 12 |
| DAHB topology | | | |

The proposed topology controls the output current of each phase through a control variable ζ as there is a predictable and linear relationship between ζ and Iₒ, as provided by the expression Iₒ=ζKVₛ. This is in contrast to the 2-level, T-type, and 3-level NPC, where the control variables define the output voltage, and an additional level of complexity is then needed to relate the output voltage to output current. The control relationship used by the existing topologies can depend on a multitude of factors and parameters such as output filter parasitics and parameters of the grid, which are often not well-defined. Therefore, the practical controllability of the proposed topology, especially for power applications tied to grid, can be more straightforward than with other topologies.

Performance characteristics of the topologies are also compared. The proposed topology is the only topology with partial-power processing properties, which can be leveraged to improve overall efficiency. All four topologies are capable of soft-switching without any additional auxiliary circuits given a suitable variable frequency range, which can give improvements for both light-load and full-load efficiencies. However, the inherent current output of the proposed topology can potentially offer improved reliability over grid-following voltage-source inverters. An improper control calculation of a voltage-source inverter can result in potentially damaging amounts of currents, whereas for the proposed topology the worst outcome from an erroneous control calculation is the maximum allowable current being actuated, which in a proper design the hardware should be sized to handle.

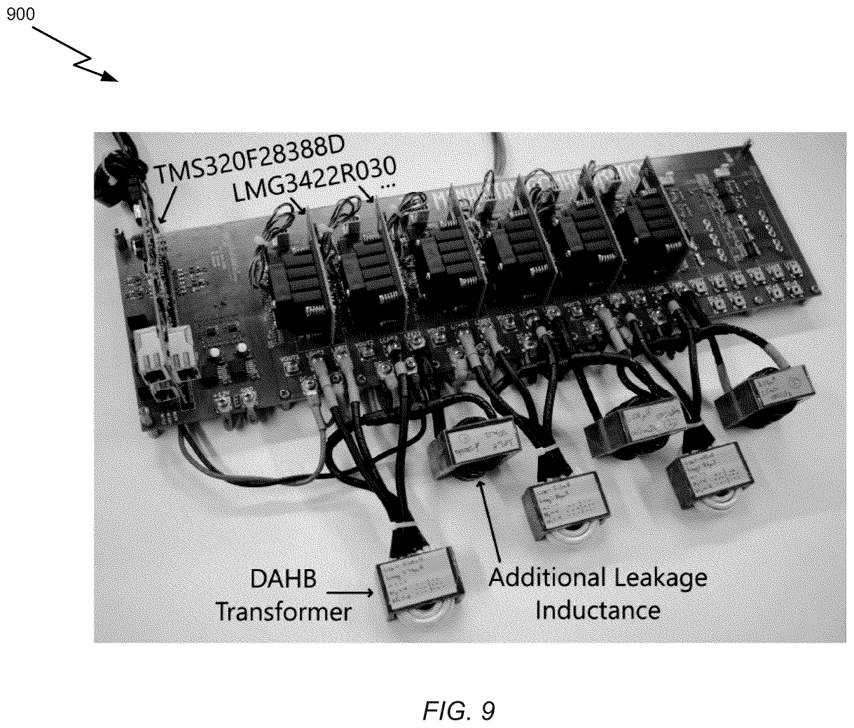

To test and evaluate performance of the proposed implementations, several experiments were conducted. FIG. 9 is a photograph 900 of an example experimental prototype that was used to validate the proposed inverter framework. Each half-bridge of the experimental inverter prototype was constructed from Texas Instruments LMG342xR050 integrated GaN FETs, with the value of each capacitor within the stacked DAHB (C1-4, illustrated in FIGS. 2A-B) being 3 μF. TDK Ceralink ceramic capacitors were used for their high ripple current handling characteristics. The transformer was composed of two Ferroxcube E43/10/28 3F36 cores in an EE configuration along with four primary and four secondary turns of 2625/44 Litz wire. The resulting magnetization inductance, L_{mag}, and leakage inductance are 65 μH and 0.42 μH, respectively. An additional inductance of 3 μH is placed in series with the transformer to give a total leakage inductance L_{Lk} of 3.5 μH. It is important to note that this additional leakage inductance is not fundamentally necessary and that a more optimized implementation can exclusively rely on the intrinsic leakage inductance of the transformer. A low leakage inductance transformer was chosen for this application so the total leakage inductance could be more easily experimentally varied. A Texas Instruments TMS320F28388D microcontroller is used to actuate the gate PWMs, read the sensors, and execute the control with an update frequency of 50 kHz. The bandwidth of the current and voltage sensors are limited to 100 kHz, below the allowable switching frequency range, so neither the fixed nor variable switching frequencies noticeably affect control measurements. The zero voltage controller uses PI gains of k_{p,zs}=1 and k_{i,zs}=3 for the proportional and integral gains, respectively. The three dq0 current PI controllers have identical gains of k_{p,ζ}=0.001 and k_{i,ζ}=1. These gain values were found empirically and limit the bandwidth in the dq0 space to roughly 2 Hz. Note that this does not reflect the maximum grid frequency this inverter can interface with. Using the techniques described herein, the open-loop bandwidth of the experimental prototype, when operating with a grid that has an inductance of 450 μH, can be determined to be approximately 4.5 kHz. This places an upper bound on the grid frequency the experimental implementation of the proposed inverter can interface with.

The various experiments performed using the inverter prototype of FIG. 9 were conducting when interfacing with a 450 V_{DC} link, and 208 Vₗ₋ₗ 60 Hz grid that had an inductance of L_{g}=450 μH. Both constant f_{sw} and variable f_{sw} schemes have been experimentally validated. All output grid voltage V₀ measurements were taken with respect to the negative DC link. A Tektronix MSO58 oscilloscope with IMDA power analyzer software, P5200A voltage probes, and TCP0030A current probes were used for all measurements. The inductor current I_{Lk} refers to the current measured through the series leakage inductance of the transformer. I_{DC} is the measured DC link current.

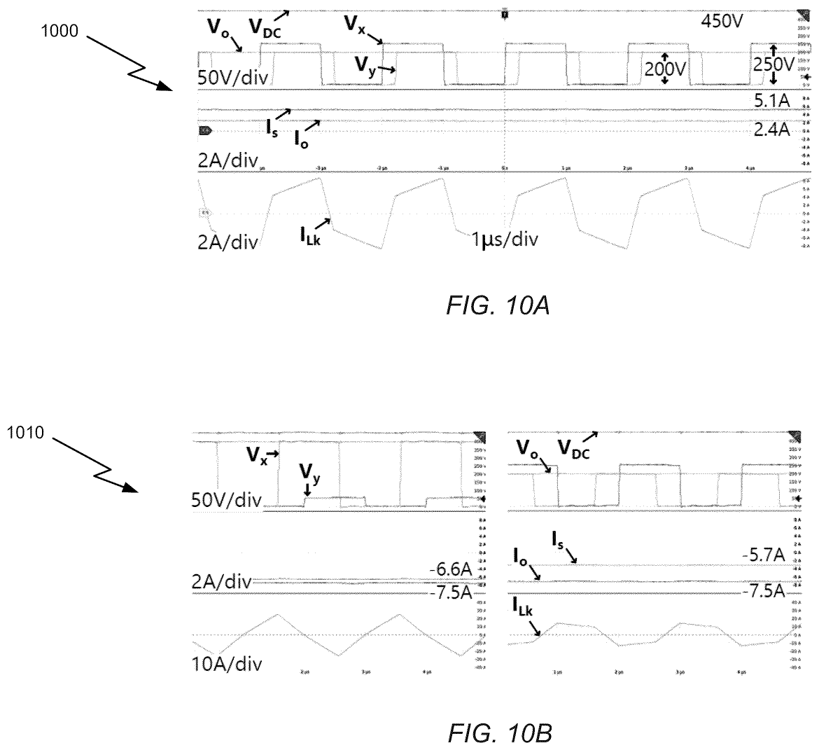

FIGS. 10A and B are graphs illustrating the switching waveforms 1000 and 1010 of the single stacked DAHB. These results are found with the stacked DAHB configured as an open-loop DC/DC converter with a 450 V_{DC} link and f_{sw} of 500 kHz. An additional regenerative DC power supply is connected across the output Vo and is used to set the output voltage. FIG. 10A shows a switching waveform for a constant value of ϕ=0.3 and an output voltage Vₒ=200V. Typical DAHB operation can be noted in the inductor current and transformer voltages. Proper actuation of ϕ can be seen in the phase difference between Vx primary and V_{y} secondary nodes. FIG. 10B shows switching waveforms corresponding to two test conditions, both with ϕ=−0.4, but with different output voltages. It can be seen that the output current Iₒ is the same for both values of output voltage, which demonstrates the current source functionality of the proposed topology.

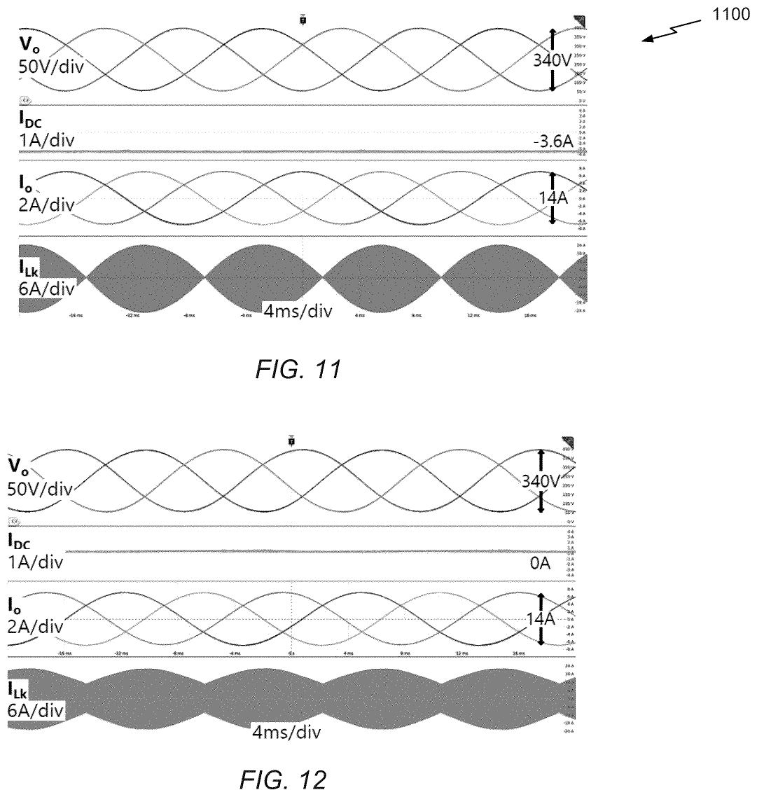

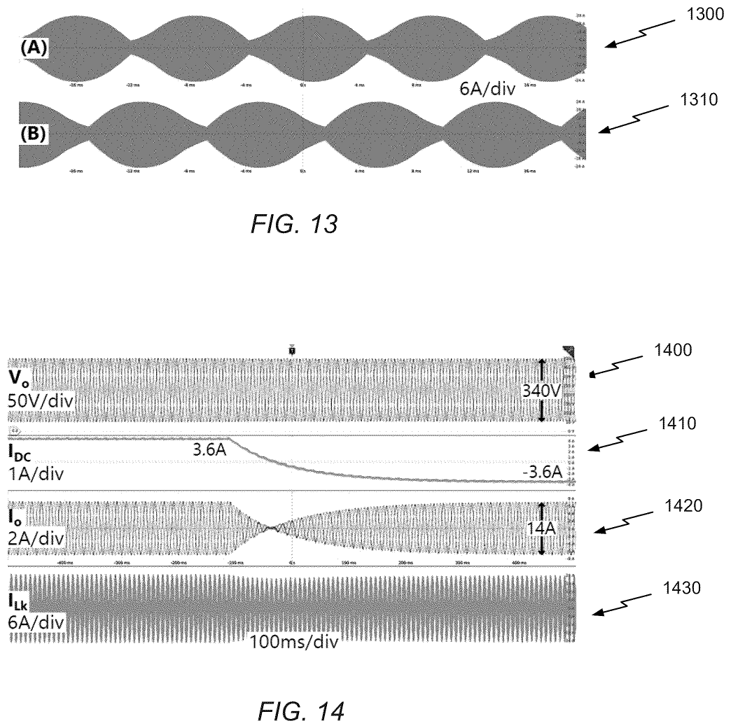

Experimental results for the constant f_{sw} control scheme are provided in FIGS. 11-16. All results for the constant f_{sw} control scheme were obtained using a f_{sw} of 500 kHz. FIG. 11 includes plots of the three-phase grid current Iₒ and voltage Vₒ, inductor current I_{Lk}, and DC link current I_{DC} for constant f_{sw} control with I_{d}=7 A and I_{q}=0 A. FIG. 12 includes plots of the three-phase grid current Iₒ and voltage Vₒ, inductor current I_{Lk}, and DC link current I_{DC} for constant f_{sw} control with I_{d}=0 A and I_{q}=7 A. Minimal distortion can be noted in the grid current and voltage waveforms. The DC current is also free of any strong harmonics. For the real power case of FIG. 11, the envelope of the inductor current pinches off to zero because the current provided to the grid at the zero crossing of the voltage and current is zero and the DAHB primary and secondary voltages are equal. This condition does not occur for the reactive power case of FIG. 12 where the inductor current never pinches off to zero. FIG. 13 includes plots 1300 and 1310 showing inductor current envelopes for I_{q}=−4 A and I_{q}=4 A (both plots were generated with I_{d}=6 A). As illustrated in the plots 1300 and 1310, the envelope of the inductor current changes with different proportions of I_{d} and I_{q}.

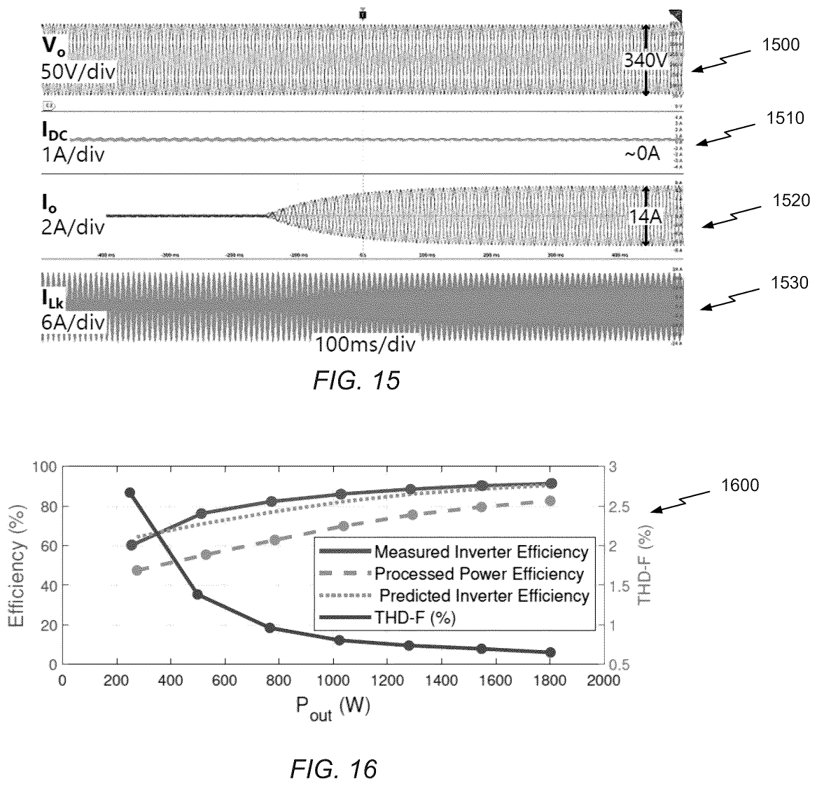

FIGS. 14 and 15 show the real and reactive power steps, respectively, of the proposed inverter. Particularly, FIG. 14 includes plots for three-phase grid current Iₒ (plot 1420), voltage Vₒ (plot 1400), inductor current I_{Lk} (plot 1430), and DC link current I_{DC} (plot 1410) for constant f_{sw} control with a −5 to 5 A I_{d} step. FIG. 15 includes plots for three-phase grid current Iₒ (plot 1520), voltage Vₒ (plot 1500), inductor current I_{Lk} (plot 1530) and DC link current I_{DC} (plot 1510) for constant f_{sw} control with 0 to 7 A I_{q} step. The plots of FIGS. 14 and 15 demonstrate the bidirectional functionality of the three-phase PPP stacked DAHB inverter topology described herein. A rise time in d and q current of roughly 200 ms can be noted, which corresponds to a closed-loop bandwidth of 2 Hz in the dq0 space. It can be seen that the magnitude of the inductor current envelope during these steps does not change with the average output power. This may be disadvantageous for efficiency since excessive currents during low power operation will drive excessive loss. However, the variable f_{sw} scheme (as described below) mitigates this problem.

FIG. 16 is a graph 1600 with plots illustrating the efficiency and THD-F measurements of the proposed inverter operating under the constant f_{sw} scheme. Particularly, FIG. 16 shows the measured and predicted overall inverter efficiency and processed power efficiency of the constant f_{sw} scheme with grid current THD-F results. Pₒᵤₜ (the x-axis) is the total 3-phase power provided to the grid. The maximum power is limited to 1.8 kW as this is the power level where the associated peak output current will saturate ϕ. The processed power efficiency is calculated using a measured mapping of the efficiency of the DAHB module and the internally actuated ϕ operating at f_{sw}=500 kHz. The predicted efficiency is then found using this experimental DAHB efficiency mapping in conjunction with the relationship between efficiencies and the ratio of processed power to output power. The graph 1600 indicates an efficiency improvement of more than 9% for all power level, in line with what is predicted using the expression,

$$η = \frac{{η}^{′}}{{η}^{′} ( 1 - α ) + α}$$

where η′ is the efficiency of the power processing converter, and α is and the ratio of power processed to power output. The THD-F of the grid current is below 1% for output powers greater than 750 W.

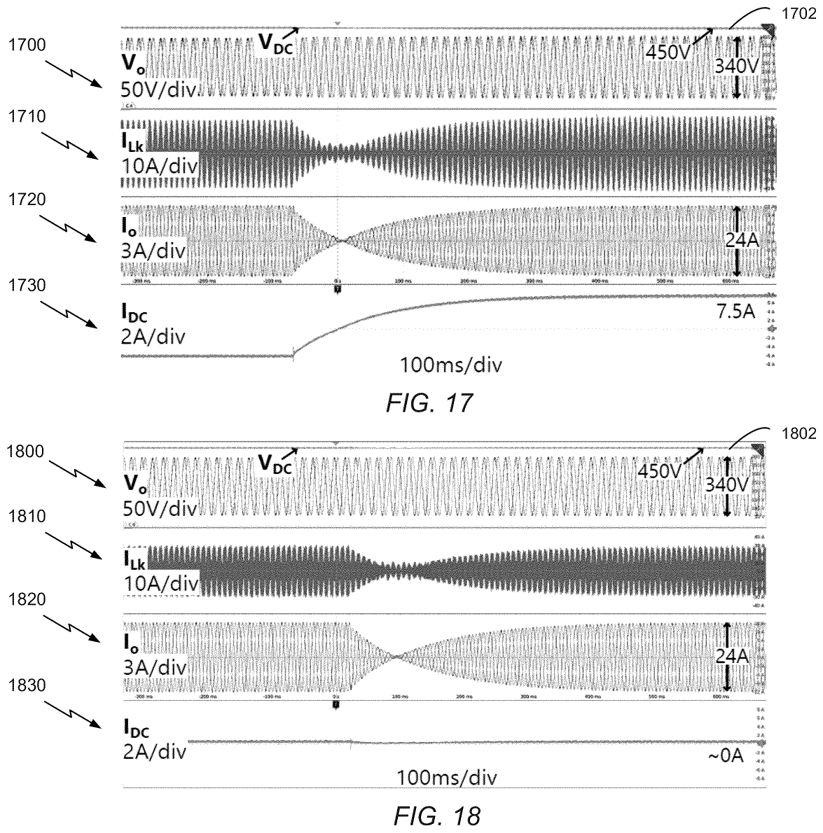

FIGS. 17-21 show the experimental results of the proposed inverter operating with the variable f_{sw} scheme. The allowable range of f_{sw} was up to 1 MHz. The most notable difference between the experimental results of the constant f_{sw} and variable f_{sw} schemes is the inductor current envelope for different output currents. FIGS. 17 and 18 show I_{d} and I_{q} steps, respectively, of the variable f_{sw} scheme. In particular, FIG. 17 includes plots for three-phase grid current Iₒ (plot 1720), voltage Vₒ (plot 1700), inductor current I_{Lk} (plot 1710), DC link voltage V_{DC} (plot 1702), and DC link current I_{DC} (plot 1730) for variable f_{sw} control with a 14 to −14 A I_{q} step. FIG. 18 includes plots for three-phase grid current Iₒ (plot 1820), voltage Vₒ (plot 1800), inductor current I_{Lk} (plot 1830), DC link voltage V_{DC} (plot 1802), and DC link current I_{DC} (plot 1830) for variable f_{sw} control with a 14 to −14 A I_{d} step. It can be seen that the magnitude of the inductor current envelope changes as the output current changes, which allows light load efficiency improvements when compared to the constant f_{sw} scheme performance.

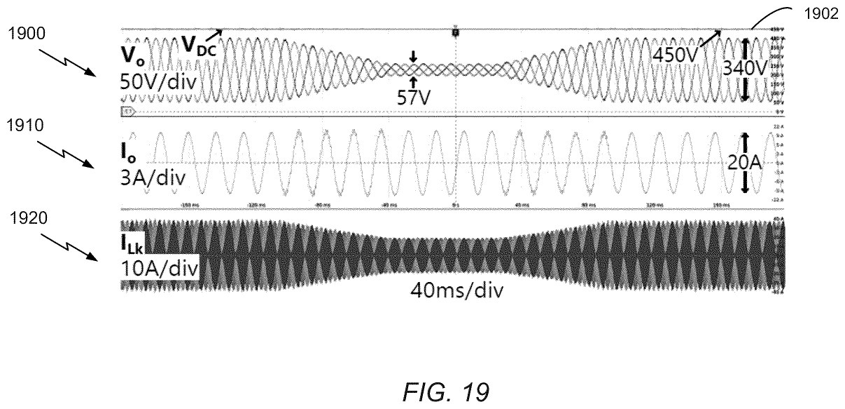

FIG. 19 includes plots showing a grid voltage sag of 120 Vₗ₋ₙ to 20 Vₗ₋ₙ over four cycles of the grid. In particular, FIG. 19 includes plots of the three-phase grid current Iₒ (plot 1910), voltage Vₒ (plot 1900), inductor current I_{Lk} (plot 1920), and DC link voltage V_{DC} (plot 1902) during a grid voltage sag of 17% of the nominal value. It can be seen that during this voltage sag event the grid current is unchanged aside from small distortions that can be attributed to common-mode grid voltage fluctuations. This demonstrates the current source performance of the proposed topology since functionality during this voltage sag event can be maintained indefinitely with minimal interruption to the grid current.

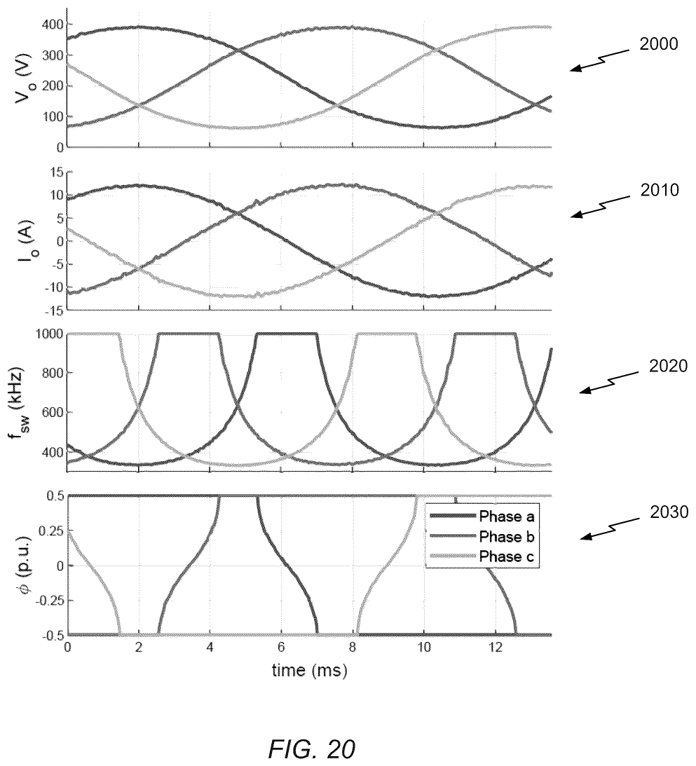

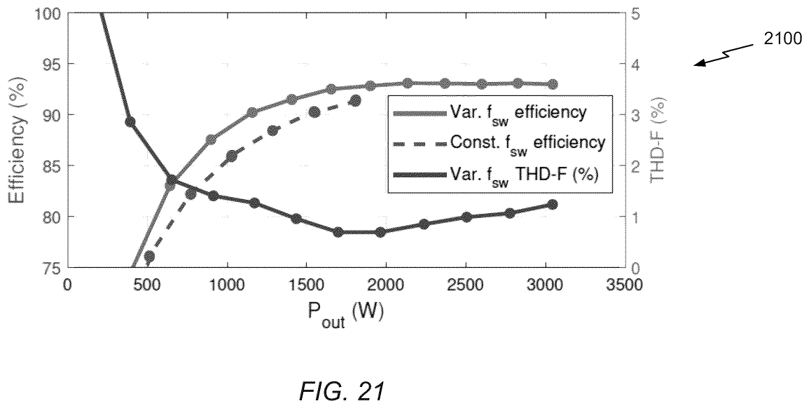

FIG. 20 includes plots shows the behavior of f_{sw} (plot 2020), ϕ (plot 2030), Io (plot 2010), and Vₒ (plot 2000) as actuated and measured by the microcontroller over one cycle of the grid with I_{d} of 12 A. The relationship between f_{sw}, ϕ, and output current aligns with the expected theoretical behavior (as described above). Noise in the Vₒ and Iₒ measurements can be attributed to non-idealities of the physical hardware sensors.

Lastly, FIG. 21 shows the efficiency and grid current THD-F of the variable f_{sw} scheme over a range of output powers (with an efficiency plot for the constant f_{sw} scheme included for reference). The THD-F is less than 2% for output power greater than 500 W. Unlike the constant f_{sw} scheme, the maximum output power for the variable f_{sw} scheme is not limited by the saturation of ϕ, allowing for a significant increase in the allowable output power. An efficiency improvement of 2-4% and an increase in maximum output power of roughly 90% over the constant f_{sw} scheme can be noted.

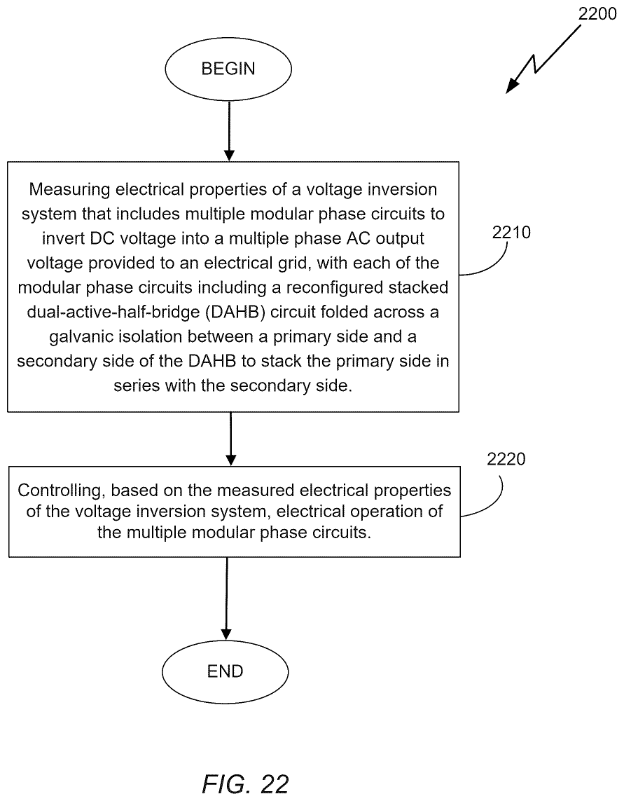

With reference to FIG. 22, a flowchart of an example procedure 2200 for DC/AC voltage inversion is provided. The procedure includes measuring 2210 electrical properties of a voltage inversion system that includes multiple modular phase circuits to invert DC voltage into a multiple phase AC output voltage provided to an electrical grid, with each of the modular phase circuits including a reconfigured stacked dual-active-half-bridge (DAHB) circuit folded across a galvanic isolation between a primary side and a secondary side of the DAHB to stack the primary side in series with the secondary side. The procedure 2200 further includes controlling 2220, based on the measured electrical properties of the voltage inversion system, electrical operation of the multiple modular phase circuits.

In various embodiments, controlling the electrical operation of the multiple modular phase circuits can include actuating one or more controllable switching devices included in each of the reconfigured stacked DAHB circuits of three modular phase circuits of the voltage inversion system to achieve a 3-phase grid voltage output.

Actuating the one or more controllable switching devices included in the reconfigured stacked DAHB circuits can include measuring, using sensor devices connected to output of the voltage inverter system, grid currents and output voltages produced by the multiple modular phase circuits and provided to the electrical grid, determining, using a phase-locked-loop (PLL) device, the instantaneous phase, θ, of the electrical grid, transforming, based at least on the determined instantaneous phase θ, the measured grid currents and output voltages into transformed grid currents and output voltages in a dq0 space, and deriving, based on the dq0 transformed grid currents and output voltages, switch actuation signals to actuate the one or more switching devices of the each of the reconfigured stacked DAHB circuits. Deriving switch actuation signals may include deriving for each of the stacked DAHB circuits, based on the dq0 transformed grid currents and output voltages, control values for control variable, ζᵢ, with i identifying the multiple modular phase circuits, to control electrical behavior of the respective stacked DAHB circuits, and determining, based on the control values for ζᵢ, switch frequencies, f_{sw,i}, control signals applied to respective switching devices of the each of the stacked DAHB circuits, and phase differences, ϕᵢ, between the respective control signals for each of the stacked DAHB circuits. The control values ζᵢ are each related to the power transferred across respective inductive couplings of the stacked DAHB circuits according to P_{ϕ,i}=KᵢV_{C,u,i}V_{C,l,i}ζᵢ, with

$${K}_{i} = \frac{{N}_{p , i}}{{N}_{s , i} 8 {f}_{sw , i} {L}_{Lk , i}} ,$$

with ζ=ϕ(1−|ϕ|), and with V_{C,u,i} being the sum of the voltages across primary side capacitors of the i^{th} stacked DAHB circuit, and V_{C,l,i} is the sum of the voltages across secondary side capacitors of the i^{th} stacked DAHB circuit. In various examples, deriving for each of the stacked DAHB circuits respective control values ζᵢ can include deriving control values ζᵢ that produce dynamically varying switching frequency, f_{sw,i} to maintain soft-switching performance of the respective stacked DAHB circuits.

Performing the various techniques and operations described herein may be facilitated by a controller device (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, the implementation of a multi-phase (e.g., three phases) inverter operations. The storage device may thus include a computer program product that when executed on the controller device (which, as noted, may be a processor-based device) causes the controller device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A voltage inverter system comprising:
multiple modular phase circuits to invert DC voltage into a multiple phase AC output voltage provided to an electrical grid, wherein each of the modular phase circuits comprises a reconfigured stacked dual-active-half-bridge (DAHB) circuit folded across a galvanic isolation between a primary side and a secondary side of the DAHB to stack the primary side in series with the secondary side; and
one or more controllers to control electrical operation of the multiple modular phase circuits.

2. The voltage inverter of system of claim 1, wherein the reconfigured stacked DAHB circuits of the multiple modular phase circuits are configured to perform partial power processing.

3. The voltage inverter of system of claim 2, wherein the reconfigured stacked DAHB circuits configured to perform partial power processing are configured to have at least part of input power to the respective reconfigured stacked DAHB circuits bypass the galvanic isolations between the primary side and the secondary side of the respective reconfigured stacked DAHB circuits.

4. The voltage inverter system of claim 1, wherein the one or more controllers configured to control electrical operation of the multiple modular phase circuits are configured to perform one of: maintain soft-switching operations for switching devices coupled to capacitors of the respective reconfigured stacked DAHB circuits, or maintain substantially constant switching frequencies for the respective reconfigured stacked DAHB circuits.

5. The voltage inverter system of claim 1, wherein the multiple modular phase circuits include three modular phase circuits.

6. The voltage inverter system of claim 1, wherein each reconfigured stacked DAHB circuit comprises:
a primary section including two primary capacitors arranged in series, two switching devices arranged in series, with the series arrangement of the two primary capacitors placed in parallel to the series arrangement of the two primary switching devices, and a primary inductive element connecting a common terminal of the two primary capacitors and a common terminal of the two primary switching devices; and
a secondary section including two secondary capacitors arranged in series, two secondary switching devices arranged in series, with the series arrangement of the two secondary capacitors placed in parallel to the series arrangement of the two secondary switching devices, and a secondary inductive element connecting a common terminal of the two secondary capacitors to a common terminal of the two secondary switching devices;
wherein a terminal of one of the two primary capacitors is electrically coupled to a terminal of one of two secondary capacitors;
and wherein the primary inductive element is inductively coupled to the secondary inductive element.

7. The voltage inverter system of claim 6, wherein the primary and secondary inductive elements correspond to a primary winding and a secondary winding of a transformer corresponding to the galvanic isolation.

8. The voltage inverter system of claim 1, wherein each of the reconfigured stacked DAHB circuits comprises one or more controllable switching devices, and wherein the one or more controllers include:
sensor devices, connected to the output of the voltage inverter system, to measure grid currents and output voltages produced by the multiple modular phase circuits;
a phase-locked-loop (PLL) device to determine the instantaneous phase, θ, of the electrical grid; and
one or more processor-based devices to:
transform, based at least on the determined instantaneous phase θ, the measured grid currents and output voltages into transformed grid current and output voltages in a dq0 space; and
derive based on the dq0 transformed grid currents and output voltages switch actuation signals to actuate the one or more controllable switching devices of the each reconfigured stacked DAHB circuit.

9. The voltage inverter system of claim 8, wherein the one or more processor-based devices configured to derive switch actuation signals are configured to:
derive for each of the stacked DAHB circuits, from the respective multiple modular phase circuits, based on the dq0 transformed grid currents and output voltages, control values for control variable, ζᵢ, with i identifying the multiple modular phase circuits, to control electrical behavior of the respective stacked DAHB circuits; and
determine, based on the control values for ζᵢ, switch frequencies, f_{sw,i}, of control signals applied to respective switching devices of the each of the stacked DAHB circuits, and phase differences, ζᵢ, between the control signals for each of the stacked DAHB circuits.

10. The voltage inverter system of claim 9, wherein the control values ζᵢ are each related to the power transferred across respective inductive couplings of the stacked DAHB circuits according to:
$${P}_{ϕ , i} = {K}_{i} {V}_{C , u , i} {V}_{C , l , i} ζ i ,$$
$$wherein {K}_{i} = \frac{{N}_{p , i}}{{N}_{s , i} 8 {f}_{sw , i} {L}_{Lk , i}} ,$$
$$wherein ζ = ϕ ( 1 - \vert ϕ \vert ) ,$$
and wherein V_{C,u,i} is the sum of the voltages across primary side capacitors of the i^{th} stacked DAHB circuit, and V_{C,l,i} is the sum of the voltages across secondary side capacitors of the i^{th} stacked DAHB circuit.

11. The voltage inverter system of claim 9, wherein the one or more processor-based devices configured to derive for each of the stacked DAHB circuits respective control values ζᵢ are configured to:
derive control values ζᵢ that produce dynamically varying switching frequency, f_{sw,i} to maintain soft-switching performance of the respective stacked DAHB circuits.

12. The voltage inverter system of claim 11, wherein the one or more processor-based devices configured to derive control values ζᵢ to maintain soft-switching performance of the respective stacked DAHB circuits are configured to:
derive control values ζᵢ that produce the dynamically varying switching frequency, f_{sw,i}, in which |ϕᵢ| is set to greatest possible value for a particular allowable switching frequency range for f_{sw,i}.

13. The voltage inverter system of claim 9, wherein the one or more processor-based devices configured to derive for each of the stacked DAHB circuits respective control values ζᵢ are configured to:
derive for each of the stacked DAHB circuits respective control values ζᵢ to cause the stacked DAHB circuit to act as current sources.

14. A DC/AC voltage inversion method comprising:
measuring electrical properties of a voltage inversion system that includes multiple modular phase circuits to invert DC voltage into a multiple phase AC output voltage provided to an electrical grid, wherein each of the modular phase circuits comprises a reconfigured stacked dual-active-half-bridge (DAHB) circuit folded across a galvanic isolation between a primary side and a secondary side of the DAHB to stack the primary side in series with the secondary side; and
controlling, based on the measured electrical properties of the voltage inversion system, electrical operation of the multiple modular phase circuits.

15. The method of claim 14, wherein controlling the electrical operation of the multiple modular phase circuits comprises:
actuating one or more controllable switching devices included in each of the reconfigured stacked DAHB circuits of three modular phase circuits of the voltage inversion system to achieve a 3-phase grid voltage output.

16. The method of claim 15, wherein actuating the one or more controllable switching devices included in the reconfigured stacked DAHB circuits comprises:
measuring, using sensor devices connected to output of the voltage inverter system, grid currents and output voltages produced by the multiple modular phase circuits and provided to the electrical grid;
determining, using a phase-locked-loop (PLL) device, the instantaneous phase, θ, of the electrical grid;
transforming, based at least on the determined instantaneous phase θ, the measured grid currents and output voltages into transformed grid currents and output voltages in a dq0 space; and
deriving, based on the dq0 transformed grid currents and output voltages, switch actuation signals to actuate the one or more switching devices of the each of the reconfigured stacked DAHB circuits.

17. The method of claim 16, wherein deriving switch actuation signals comprises:
deriving for each of the stacked DAHB circuits based on the dq0 transformed grid currents and output voltages, control values for control variable, ζᵢ, with i identifying the multiple modular phase circuits, to control electrical behavior of the respective stacked DAHB circuits; and
determining, based on the control values for ζᵢ, switch frequencies, f_{sw,i}, control signals applied to respective switching devices of the each of the stacked DAHB circuits, and phase differences, ϕᵢ, between the respective control signals for each of the stacked DAHB circuits.

18. The method of claim 17, wherein the control values ζᵢ are each related to the power transferred across respective inductive couplings of the stacked DAHB circuits according to:
$${P}_{ϕ , i} = {K}_{i} {V}_{C , u , i} {V}_{C , l , i} ζ i ,$$
$$wherein {K}_{i} = \frac{{N}_{p , i}}{{N}_{s , i} 8 {f}_{sw , i} {L}_{Lk , i}} ,$$
$$wherein ζ = ϕ ( 1 - \vert ϕ \vert ) ,$$
and wherein V_{C,u,i} is the sum of the voltages across primary side capacitors of the i^{th} stacked DAHB circuit, and V_{C,l,i} is the sum of the voltages across secondary side capacitors of the i^{th} stacked DAHB circuit.

19. The method of claim 17, wherein deriving for each of the stacked DAHB circuits respective control values ζᵢ comprises:
deriving control values ζᵢ that produce dynamically varying switching frequency, f_{sw,i} to maintain soft-switching performance of the respective stacked DAHB circuits.

20. A non-transitory computer readable media comprising computer instructions executable on a processor-based device to:
obtain measurements of electrical properties of a voltage inversion system that includes multiple modular phase circuits to invert DC voltage into a multiple phase AC output voltage provided to an electrical grid, wherein each of the modular phase circuits comprises a reconfigured stacked dual-active-half-bridge (DAHB) circuit folded across a galvanic isolation between a primary side and a secondary side of the DAHB to stack the primary side in series with the secondary side; and
control, based on the measured electrical properties of the voltage inversion system, electrical operation of the multiple modular phase circuits.
